(19) United States
(12) Patent Application Publication
(10) Pub. No.: US 2026/0365422 A1
(43) Pub. Date: Nov. 19, 2026

(54) Mobile Device for Collecting and Compacting Waste

(71) Applicant: DLR GbR, Gräfelfing (DE)

(72) Inventors: Christian Joseph Lukas, Gräfelfing (DE); Daniel Christoph Davenport, Gräfelfing (DE); Andrzej Von Schuttenbach Pyziak, Gräfelfing (DE)

(21) Appl. No.: 19/477,764

(22) PCT Filed: Apr. 11, 2024
(86) PCT No.: PCT/EP2024/059888

§ 371 Date: Oct. 22, 2025

(30) Foreign Application Priority Data
Apr. 26, 2023 (EP) 23170158.2

(51) Int. Cl. B65F 1/06; B65F 1/14; B65F 1/16

(52) U.S. Cl. CPC B65F 1/06; B65F 1/1405; B65F 1/1473; B65F 1/1607; B65F 2001/1676; B65F 2210/162; B65F 2210/167; B65F 2210/179; B65F 2210/181; B65F 2210/188

(57) ABSTRACT

The disclosure relates to a mobile device for collecting and compacting waste including: a container for receiving a waste bag and a cover device. The cover device interacts with the opening of the container in a form-fitting manner such that a waste bag introduced into the container can be sealed in an air-tight manner. The mobile device includes means for generating compressed air; means for generating negative pressure; means for thermally welding a waste bag introduced into the container; and means for displacing the mobile device, characterized in that the cover device has a suction opening for negative pressure, the device has means for displacing a base plate with respect to the side walls of the container, and the container has an inlet opening and an inlet valve for compressed air.

### CROSS REFERENCE TO RELATED APPLICATIONS

This application is a § 371 national stage of international application no. PCT/EP 2024/059888, filed on Apr. 11, 2024, which claims priority to European application no. 23170158.2, filed on Apr. 26, 2023, the entire contents of both of which are hereby incorporated by reference herein.

### FIELD

The present invention relates to a mobile device for collecting and compacting waste, in particular a waste container. Specifically, the present invention relates to a device with the features of the preamble of claim 1. The present invention also relates to a method for collecting and compacting waste.

### BACKGROUND

Devices for collecting and compacting waste are known in the art. For example, EP 209 639 A1 discloses a device for compacting kitchen waste. In the device, the introduced waste is subjected to atmospheric pressure by extracting the air with a pump, thereby compressing it.

EP 1 498 364 A1 discloses a device for collecting and disposing of dry waste, wet waste and the like. The device comprises a container with a lid, which is fixed by hermetic closure elements, with a piston inside which can slide and forms a hermetic chamber. Waste compacting and liquid dispensing elements, as well as air and liquid suction elements, which are connected to the chamber and the interior of a flexible container, are also provided. However, the piston is only retracted by a spring; the waste is not actively compressed.

WO 2007/076964 A1 discloses a waste container with a bag located therein and a vacuum pump for extracting gas, in particular air, out of the bag, wherein a pressing device is provided, with which a material can be pressed inside the bag before the gas is extracted and can be compressed in this manner. However, details of the pressing device are not disclosed, merely a pressing plate moving “downwards”. The publication also discloses a sealing device for sealing the bag in a gas-tight manner.

In the waste containers known in the prior art, therefore, essentially only the atmospheric pressure is used to compact the waste bag, or a pressing plate, which is not defined in any more detail, is moved “downward”. Due to the typically high amount of space required by waste, comprising garbage, rubbish, containers or the like and low levels of compression, both space and material are used unnecessarily for the collection, storage and disposal of the waste, typically in a waste bag.

### SUMMARY

The object of the present invention is to overcome the above-mentioned disadvantages of the prior art and, in particular, to provide a mobile waste container in which waste can be collected and stored, compacted to the greatest extent as possible, and then disposed of cleanly, while also being easy to operate.

This object is achieved according to the present invention with a mobile device (1) for collecting and compacting waste, comprising
a) a container (2) for receiving a waste bag comprising side walls (3), a bottom plate (4) and a first seal (5) at the opening (6),
b) a lid device (7) with a second seal (8), the lid device being configured and arranged such that it can be brought into an open position opposite the opening (6) of the container (2) so that the opening (6) of the container (2) is accessible for introducing a waste bag, and can be brought into a closed position opposite the opening (6) of the container (2) so that the lid device (7) interacts positively with the opening of the container (2) in such a way that a waste bag introduced into the container (2) can be sealed airtight against the lid device (7) between the first seal (5) and the second seal (8),
c) means (9) for generating compressed air,
d) means (10) for generating negative pressure,
e) means (11) for thermally welding a waste bag introduced into the container (2) when the lid device is in the closed position, the means being located at the opening (6) of the container and/or at the lid device (7), and
f) means (31) for (horizontally) displacing the mobile device (1), wherein within the device
g) the lid device (7) has a suction opening (12), which is arranged on the lid device (7) in such a way that, in the closed position, the gaseous atmosphere can be partially extracted from the interior of a waste bag introduced into the container (2) by means of the means (10) for generating negative pressure;
h) the container (2), when the opening (6) is closed, is airtight;
i) the bottom plate (4) of the container is displaceable with respect to the side walls (3), and in the closed position in the direction of the lid device (7)
j) the device has means (14) for displacing the bottom plate (4) with respect to the side walls (3), and
k) the container (2) has an inlet opening (15) for compressed air, which can be supplied with compressed air, which is provided by the means (9) for generating compressed air, in a controlled manner by means of an inlet valve (16).

The object is also achieved by a method for collecting and compacting waste, comprising
a) the step of extracting a part of the gaseous atmosphere from a waste bag containing waste, while
b) simultaneously mechanically compressing the waste bag and
c) simultaneously applying external air pressure to the waste bag.

This method can be carried out particularly advantageously by a mobile device according to the present invention.

Advantageous embodiments of the device and the method are the subject of the subclaims.

The invention is based on the finding that it is particularly advantageous to collect and compact waste if the compaction is carried out not only by extracting the air out of the waste bag, but in particular by additionally mechanically compressing the waste bag and subjecting it to compressed air. This leads in a simple way to waste requiring a particularly low amount of space and making the best possible use of resources.

The invention will now be described in further detail by way of preferred embodiments.

The mobile device according to the invention for collecting and compacting waste comprises a container for receiving a waste bag. Typical containers are known in the art, and are usually cuboidal or cylindrical. The container comprises an opening, typically the, preferably complete, top side, as well as side walls, typically the 4 side walls of the cuboid or the cylinder lateral surface of the cylinder, and a container bottom. According to the invention, the container is airtight when the opening is closed. This means that the side walls and the container bottom or the displaceable bottom plate inside the container form a hermetically sealed space if the opening were sealed airtight. Suitable materials are plastics or metals, in particular glass fiber-reinforced plastics, e.g. GRP 30 or GRP 40, PEEK plastics, PA6, as well as stainless steel or aluminum.

The container of the device according to the invention also has a first seal at the opening, typically on a surface of the top of the container perpendicular to the side walls (and parallel to the container bottom). The seal surrounds the opening, that is to say it encloses the entire opening of the container. This seal is suitable for effecting an airtight closure of the opening with a typical waste bag, with a corresponding interaction with the second seal on the lid device. Suitable seal materials are known in the art.

Insofar as seals are used in the present invention, the person skilled in the art is generally familiar with suitable sealing materials. Typical materials include silicone, silicone foam, EPDM, NBR, CR, cellular rubber, foam rubber, fluoroelastomers, e.g. Viton®, fiber seal based on aramid fibers, e.g. KLINGERSIL®, PTFE (Teflon®), polyurethane (Vulkollan®), PVC and PMMA. Preferred materials are EPDM and silicone for the first, second, and fourth seals. Fluoroelastomers, e.g. Viton®, are preferably used as a seal against the welding and cutting electrodes.

In a preferred embodiment, the device has means for fixing a waste bag to the opening of the container, preferably a clamping frame or clamps. Such a clamping frame is fastened to the container by means of a hinge, for example, and encloses the entire opening of the container. Accordingly, when the frame is folded away, the opening is freely accessible so that a waste bag can be inserted into the container with the waste bag coming into contact with the first seal at the opening. The clamping frame or the clamps are then closed and are thus able to fix the waste bag to the container. In one embodiment, the first seal, with the covering waste bag, is not or only partially covered by the means for fixing a waste bag, and remains essentially accessible, in particular for interaction with the second seal of the lid device. In an alternative embodiment, the first seal is contacted by the means for fixing a waste bag via the waste bag, if it is inserted, and, in the closed position, is also completely located between the first seal at the container opening and the second seal of the lid device. The use of a clamping frame has the advantage that the waste bag can, on insertion, be placed cleanly over the first seal at the container opening and fixed to the container via the means for fixing a waste bag, preferably the clamping frame or clamps. This results in a tight seal when the second seal on the lid device comes into contact with the waste bag, and, optionally, with the means for fixing a waste bag, in the closed position.

The container of the device according to the invention has a displaceable bottom plate inside, which is typically essentially planar. According to the invention, the bottom plate is designed as a type of piston, which is movably arranged within the container, i.e. it can be moved perpendicular to the surface of the bottom plate along the side walls. In one embodiment, the bottom plate of the container is sealed airtight against the side walls by means of a third seal. In this embodiment, when the opening is closed, the side walls and the bottom plate form the airtight interior of the container. In this embodiment, the bottom plate preferably comprises means that allow the compressed air to be guided toward the top of the bottom plate. In a preferred alternative embodiment, the bottom plate of the container is not sealed airtight from the side walls by means of the third seal; rather, when the opening is closed, the side walls and the container bottom form the airtight container. The latter embodiment has the advantage that the third seal does not have to be made airtight with respect to the compressed air as soon as this is guided into the container interior, which would place higher demands on the material to be used. An inlet opening below the bottom plate is also sufficient for feeding compressed air to the interior of the container.

The bottom plate is displaceable with respect to the side walls, and in the direction of the lid device (perpendicular to the surface of the bottom plate) when the lid device is in the closed position. For this purpose, corresponding guide grooves or strips are preferably available in the side walls. By displacing the bottom plate, the volume of the container, defined by the space into which the waste bag can be inserted, can be reduced. During displacement, the third seal (also referred to as the “seal on the bottom plate”) seals the bottom plate in an airtight manner with respect to the side walls in any position of the bottom plate, in one of the embodiments described above, typically at least to prevent dirt from getting under the bottom plate. When the opening of the container is closed, it is therefore hermetically sealed by the side walls (these are also airtight) and either through the bottom plate, or, at least, through the container bottom.

The container is referred to as airtight if, when the opening is closed, the container maintains a negative pressure of 500 mbar (absolute internal pressure) below 800 mbar (absolute internal pressure) for at least 30 minutes.

According to the invention, the container has an inlet opening for compressed air which can be supplied with compressed air, which is provided by the means for generating compressed air, preferably in a controlled manner by means of an inlet valve. Compressed air can thus be introduced into the interior of the container, which is airtight, via the inlet opening. When a waste bag is slipped over the container opening and interacts with the first seal, either via the means for fixing a waste bag or via the second seal of the lid device in the closed position, the space between the waste bag and the container is sealed airtight. The introduction of compressed air into the space between the waste bag and the container and with the lid device in the closed position thus leads to the compression and thus to the compaction of the contents of the waste bag. Preferably, according to the invention, the device is configured such that the compressed air, when used for the means for displacing the bottom plate, can also be guided to the inlet opening, and thus into the interior of the container, in a controlled manner by means of an inlet valve.

For fixing and displacing the bottom plate, the device according to the invention has means for displacing the bottom plate with respect to the side walls. These means for displacing the bottom plate are, on the one hand, typically suitable for holding the bottom plate in the position of the maximum extent of the volume of the container; in any case, they are suitable for displacing the bottom plate perpendicular to its surface and in the direction of the lid device or in the direction of the container opening, with the lid device in a closed position, in such a way that the volume of the container(interior) can be reduced. In this case, the means for displacing the bottom plate is able to move the bottom plate preferably with a compressive force of from about 50 kPa to about 1000 kPa, preferably from about 100 kPa to about 800 kPa, in particular from about 300 kPa to about 600 kPa, in the direction of the container opening. With this force, when the lid device is closed, the waste bag inserted into the container, including its contents, can be mechanically compressed. The possible extent of the displacement of the bottom plate is preferably at least such that the volume of the container, defined by the space into which the waste bag can be inserted, can be reduced by 50%, i.e. to 50% of the maximum extent, preferably by 70%, i.e. to 30% of the maximum extent, with the opening closed by the lid device (and possibly by the closure device). Suitable means for displacing the bottom plate are, for example, screw rods, hydraulic cylinders, for example with air, water or oil as the medium and preferably pneumatic cylinders or bellows. The latter pneumatic cylinders or bellows can advantageously be driven by the compressed air, which can be provided by the means for generating compressed air contained in the device according to the invention. Preferably, the means for displacing comprise return elements, for example spiral springs. The return elements cause or support a retraction (away from the lid device) of the bottom plate after the mechanical compaction of the waste bag. The return forces are typically lower than the compressive forces, preferably from about 50 kPa to about 500 kPa, preferably from about 100 kPa to about 300 kPa. In this case, the means for displacing the bottom plate is configured such that it can deliver both the compressive force specified above and the return force, i.e. the sum of the two.

The device according to the invention also has a lid device. This is configured to cover or close the opening of the container, and has a second seal for this purpose on the side that interacts with the opening of the container. The lid device is configured and arranged in the device such that it can be brought into an open position opposite the opening of the container so that the opening of the container is accessible for introducing a waste bag, and can be brought into a closed position opposite the opening of the container so that the lid device interacts positively with the opening of the container in such a way that a waste bag introduced into the container can be sealed airtight against the lid between the first seal (at the container opening) and the second seal (at the lid device). The second seal thus substantially corresponds in its extension to that of the first seal, that is to say essentially to that of the container opening. If a waste bag is inserted into the container and slipped over the opening and thus over the first seal, the waste bag is clamped and sealed between the first seal and the second seal, and optionally the means for fixing a waste bag, in the closed position. This closes the waste bag with the lid device, and the interior of the bag is only in contact with the lid device (and the bag itself).

According to the invention, two embodiments are preferred. In the first, the lid device comprises at least one throw-in flap and a throw-in funnel, the latter arranged between the container and the throw-in flap. A closure device, which can close the container at the level of its opening, is preferably provided in the latter. The first embodiment is illustrated in FIGS. 1, 2, 3, 17, 27 and 18, for example. In the second embodiment, the lid device does not comprise a throw-in funnel, but rather the throw-in flap more or less directly forms the lid for the container. The second embodiment is illustrated in FIGS. 12, 13, 14, 16 and 24 to 26, for example. These embodiments will be described in more detail below.

In the first embodiment, the lid device has at least one throw-in funnel, which optionally carries the second seal at the tapered end (lower end facing the container opening), and a throw-in flap, which closes the throw-in funnel at the wider (upper) end, preferably in an airtight manner. In this embodiment, the throw-in funnel is preferably made of the same material as the container. The throw-in flap closes the wider, typically upwardly directed opening of the throw-in funnel. The throw-in flap is typically configured such that it can be brought into an open state, preferably due to an interaction of the user with the device, e.g. due to an actuation of a button, a tread strip, or touching a control panel (touch screen). With the throw-in flap open, access to the interior of the throw-in funnel and the opening of the container is typically enabled. When the waste bag is inserted, it can thus be filled. Furthermore, the throw-in flap can be brought into a closed state. In the latter, the flap closes the upwardly directed, wider opening of the throw-in funnel, preferably in a light-tight manner. For this purpose, a (fourth) seal is located at the throw-in flap or at the corresponding opposite side, i.e. at the wide opening of the filling funnel. The latter seal comprises in its extent the upwardly directed, wider opening of the throw-in funnel in order to ensure an airtight closure of the throw-in funnel by the throw-in flap. Preferably, the lid device has a lock that interacts with the throw-in flap and is capable of reversibly holding the throw-in flap in the closed state. This ensures that the container is securely and tightly closed by the throw-in flap.

In a preferred embodiment, the throw-in flap forms part of the upper end of the device according to the invention. In this embodiment, the device according to the invention is thus a waste bin that can be filled from above.

In a preferred embodiment, the lid device has a throw-in funnel and, within the funnel, a closure device, preferably closure flaps. The closure device, preferably the closure flaps, are configured to essentially close the opening of the throw-in funnel at its tapered end (lower end facing the container opening) with the throw-in flap in the closed state. If a waste bag is inserted in the container, the latter may be covered as described below, and if the waste is mechanically compressed, it would be pressed into the throw-in funnel. The closure device can prevent this. The latter is thus closed before the mechanical pressing; if necessary, the closure device is always closed as soon as the throw-in flap is closed. In order to mechanically reinforce the closure device, preferably the closure flaps, against the mechanical pressure (with which the waste in the container is compressed), locks may be provided for the closure device, preferably the closure flaps. These locks can prevent the closure device from being pushed open by the mechanical pressure.

In the second embodiment, the device according to the invention does not have a throw-in funnel, but rather the throw-in flap forms the immediate lid of the container, which also carries the second seal. The latter thus directly closes the opening of the container. In this embodiment, the throw-in flap thus preferably does not form part of the upper end of the device according to the invention. Rather, in this embodiment, the container is preferably extendable from the device and then accessible for throwing in waste. In this embodiment, the device according to the invention is thus a waste bin that can be filled by extending the container, e.g. as a mobile waste bin, which can be pushed under a table and whose container moves out of the housing for filling.

According to the invention, the lid device has a suction opening, which is arranged on/in the lid device in such a way that, in the closed position, the gaseous atmosphere can be at least partially extracted from the interior of a waste bag introduced into the container by means of the means for generating negative pressure. As stated above, the lid device is configured such that, in the closed position, the waste bag is clamped and sealed between the first seal and the second seal, and optionally the means for fixing a waste bag. The waste bag is thus closed with the lid device, and the interior of the bag is only in contact with the lid device (and the bag itself). As a result, the gaseous atmosphere (of the bag) can be removed from the waste bag through the suction opening on the lid device. The negative pressure required for this is made available by the means for generating negative pressure, as defined further below. Preferably, a liquid sensor is provided on the lid device next to or in the suction opening. The latter makes it possible for the suction process to be stopped to protect against the contamination of the components of the device in the event that liquids pass from the waste bag to the lid device or are extracted.

In the alternative embodiment, in which the device according to the invention does not have a throw-in funnel, and rather the throw-in flap forms the lid, which also carries the second seal, the suction opening may be arranged on the throw-in flap.

The device according to the invention also has means for generating compressed air. Suitable means, e.g. pumps or compressors, are known in the art. Preferably, the generated compressed air has at least 1.0*10⁵ Pa (100 kPa, 1 bar) overpressure, preferably at least 2.0 * 105 Pa (200 kPa, 2 bar) overpressure. The compressed air can be used for introduction, via the inlet opening, into the container interior, and for the means for displacing the bottom plate, insofar as the means are operated with the aid of air, for example pneumatic cylinders or bellows.

The device according to the invention also has means for generating negative pressure. Suitable means, e.g. vacuum pumps, are known in the art. Preferably, the negative pressure that can be generated is at least 5.0*10⁴ Pa (50 kPa, 500 mbar) absolute pressure, preferably at least 2.0*10⁴ Pa (20 kPa, 200 mbar) absolute pressure. The vacuum pump must therefore be able to generate an absolute pressure of 500 mbar, preferably 200 mbar, in the container interior, and thus in the waste bag. The negative pressure is used to extract the gaseous atmosphere from the waste bag. The device preferably has suitable means, e.g. a negative pressure hose, in order to guide the negative pressure to the lid device, and in particular to the suction opening on the lid device (in particular on the throw-in flap, e.g. if the latter is arranged directly as a lid). The means for generating negative pressure preferably comprises a filter, preferably a carbon filter, and/or a liquid sensor. The latter makes it possible for the suction process to be stopped to protect against the contamination of the components of the device in the event that liquids are extracted from the waste bag.

In one embodiment, the means for generating compressed air and the means for generating negative pressure and separate assemblies, for example, a compressor and a separate vacuum pump. In a preferred embodiment, the means for generating compressed air and the means for generating negative pressure are implemented in a means for generating compressed air and negative pressure, i.e. combined in an assembly of the device according to the invention. For example, the exhaust air of a vacuum pump can be used directly as compressed air according to the invention. The means for generating compressed air and negative pressure are thus preferably a combined vacuum/compressed air pump. Suitable vacuum pumps, in which the exhaust air can also be used directly as compressed air, are known in the art, e.g. diaphragm pumps.

The device according to the invention also has a means for thermally welding a waste bag introduced into the container. The means can be located at the opening of the container and/or at the lid device. Suitable means for thermally welding plastic bags, such as waste bags made of PE (polyethylene), PP (polypropylene) or PLA (polylactide), are known in the art. Thermal welding is understood to be a process in which plastic films are first heated and then pressed together under pressure such that they are permanently bonded. Typical means for thermal welding are heating electrodes, in particular strip electrodes as are known in the art and are commercially available. Typically, a Kanthal strip or wire is used. Depending on the process, appropriate welding temperatures, somewhat in the range of 80 °C to 140 °C, are used, e.g. approx. 80 °C for thermoplastics such as PP and PE, as well as up to 140 °C for PLA films. Suitable welding times are from about 0.1 to 5 seconds, preferably about 0.5 to 3 seconds. Preferably, the welding is carried out in a temperature-controlled manner, and the temperature control is determined, as known in the prior art, via the electrical resistance of the Kanthal strip or wire. This ensures that the duration is sufficient for a full and strong weld. Suitable parameters for thermally welding plastic films (such as the dimensions of the Kanthal strip or wire and the power supply) are known in the art. Preferably, the Kanthal strip or wire is coated with a PTFE layer in order to prevent the plastic film from caking. The means located at the opening of the container and/or at the lid device are arranged in such a way that, when the lid device is in the closed position, a waste bag, which is stretched over the opening of the container, can be closed and welded to a corresponding part of the bag, for example a folded flap of the bag, or a separate part when the flap or the separate part is placed over the opening. Preferably, the means for thermal welding, in particular the strip electrodes, are arranged essentially parallel to the first and second seals, either on the lid device and/or on the container opening. In this case, the means for thermal welding are preferably arranged fully circumferentially around the container opening in order to ensure the complete closure of the waste bag. This can be achieved by the means of thermal welding, in particular the strip electrodes, which are arranged on the lid device essentially parallel to the second seal, or on the container opening essentially parallel to the first seal, in each case fully circumferentially (around the container opening). Insofar as the means for thermal welding, in particular the strip electrodes, are arranged both partially on the lid device substantially parallel to the second seal and partially on the container opening essentially parallel to the first seal, it is sufficient and preferred for the means to be arranged together essentially fully circumferentially around the container opening, i.e. to ensure that they are fully circumferential together. A fully circumferential position is ensured if there is at least a small amount of overlap of the opposite means, i.e. on the one hand on the lid device essentially parallel to the second seal, and on the other hand on the container opening essentially parallel to the first seal. This ensures the complete closure of the waste bag. With regard to the first and second seals, the arrangement of the means for thermal welding, in particular the strip electrodes, is preferably within the area spanned by the seals.

The mobile device of the present invention is typically designed as a free-standing unit, that is, it is provided with side panels and, optionally, a preferably hinged cover, including the throw-in flap. In one embodiment, when a trigger, such as a foot pedal or push button, is actuated, the cover and/or the throw-in flap pivots up or to the side. Typically, at least the side parts, possibly also the rear side of the device, are provided with parts of an outer cladding, in particular on the sides and on the rear side, in order to prevent access to the movable components and the technology and to protect the latter.

The device according to the invention is designed as a mobile device, i.e. it comprises means for displacing the device, i.e. no rigid foot or feet. Rather, means are provided for displacing the device, preferably wheels, rollers or ball rollers, which allow the device to be displaced essentially horizontally over essentially flat surfaces. Suitable means for displacement are known in the art and are commercially available. If applicable, the means for displacement can be deactivated, preferably retracted and/or folded. As a mobile unit the device can be provided with a mobile energy supply, for example batteries or most preferably with rechargeable batteries. This maximizes the mobility of the device while maintaining functionality.

The device according to the invention can thus advantageously be used as a freestanding waste container, which can possibly be moved to different locations, in particular also in a domestic, leisure or office setting.

In an embodiment, the device according to the invention has means for separating the separate part of a film with which the opening of the container and thus the inserted waste bag is covered. Means of this type, for example a cutting or tear edge, preferably a cutting electrode, are known in the art. The latter are essentially the same electrodes as those used for welding as described above, except that the welding time and/or temperature is increased, resulting in the separation of the film material. Typical temperatures are about 140 °C to about 150 °C for a period of time of about 1.5 to 3 seconds.

The device according to the invention is suitable for use with different waste bags; preferably thermally weldable plastic bags, such as waste bags, made of polyolefins, such as PE (polyethylene) and PP (polypropylene), and of polyesters, such as PLA (polylactide), are used for the device according to the invention and in the method according to the invention. Preference is given to using sealable plastic bags, in particular sealable biopolymer/bioplastic bags made of biodegradable PLA film, as are known in the art and are commercially available (for example “Planova PLA 50” from SÜDPACK Verpackungen GmbH & Co. KG, Ochsenhausen, Germany), or 100% biodegradable biopolymer/bioplastic bags based on renewable raw materials (for example Deiss Bioline from ecovio®, EMIL Deiss KG (GmbH + Co.), Hamburg, Germany). Preferably, the raw materials of the films of the waste bags are compostable according to EN 13432 and/or according to IN CERTCO/DIN CERTCO Plus.

In a preferred embodiment, the device according to the invention also has means for perforating a waste bag on the lid device, in particular on the lower end of the throw-in funnel or on the throw-in flap, if the latter serves directly as a lid for the container. These are typically located within the area spanned by the second seal, in particular on the part of the throw-in flap/funnel facing the container, so that the perforation is made possible within the area spanned by the second seal. The means are also typically arranged outside the surface spanned by the means for thermal welding. In accordance with the invention, as soon as a waste bag, which is stretched over the opening of the container, is closed with a corresponding part of the bag, for example a folded flap of the bag, or a separate part when the flap or the separate part is placed over the opening, the waste bag is mechanically pressed and/or compressed air is pressed into the container and/or the gaseous atmosphere is extracted out of the bag interior in order to compress the waste bag. However, since the waste bag is already closed by pressing on a corresponding part of the bag, for example a folded flap of the bag, or a separate part, by placing the flap or the separate part over the container opening, and by means of the lid and the second seal in the closed position, air can no longer escape from the bag interior. For this purpose, the means for perforating a waste bag creates a defined “outlet opening” on the waste bag, preferably on the cover, i.e. for example a folded flap of the bag, or on the separate part. Suitable means for perforating a waste bag are, for example, one or more spikes or cut edges. The means for perforating a waste bag can preferably be used in a controlled manner, i.e. not permanently active, preferably electrically activatable. Examples include one or more electrically extendable spikes or one or more electrically extendable blades, which then retract. This may be activated prior to a pressing or extraction step. The subsequent retraction of the means has the advantage of reducing the risk of injury when changing the waste bag. In a preferred embodiment, the means for perforating a waste bag is arranged in or near the suction opening, or perforated through the suction opening.

In a preferred embodiment, the device according to the invention comprises means for fixing the cover of the waste bag. Before the waste bag is extracted or welded, a corresponding part of the bag, for example a folded flap of the bag, or a separate part, is placed over the container opening. In order to prevent this part, referred to here as the cover, from slipping, the device according to the invention comprises means for fixing the cover of the waste bag, typically one or more clamps or clamping strips. These are preferably positioned on the front side of the container, e.g. below the container opening. Preferably, the means for fixing the cover of the waste bag, typically one or more clamps or clamping strips, interacts with spikes for fixing the cover of the waste bag. The latter are, for example, correspondingly also positioned on the front side of the container below the container opening. Preferably, safety switches are provided, for example also on the front side of the container, for example below the container opening, which are arranged so that they interact with the cover of the waste bag, e.g. are triggered by contact with it. The safety switches thus allow a check to be made as to whether the cover of the waste bag has been placed correctly. Only in the latter case should a welding or separation step be carried out.

In a preferred embodiment, the device according to the invention also has means on the lid device, preferably on the throw-in flap, for irradiating the interior of the container with UV light (380 to 100 nm), in particular UV-C light (280 to 100 nm). Irradiation of waste with UV light, in particular UV-C light, reduces and inactivates harmful microorganisms, thus reducing putrefaction and other metabolic processes, and reduces odor formation. Suitable lighting for generating UV light, in particular UV-C light, is known in the art, for example UV LEDs. The lid device, preferably on the throw-in flap, preferably also comprises a protective device for the means for irradiating the interior of the container, in particular when not in use. Suitable protective devices would be, for example, a rotatable or pivotably mounted dimming or shading of the UV lamp. In certain embodiments, the throw-in flap serves as a counterpressure surface during the mechanical pressing of the waste bag. The protective device is therefore preferably configured in such a way that it travels in front of the means for irradiating the interior of the container, for example it folds out or remains folded out, and folds back during irradiation, preferably only during irradiation, and thus clears the beam path to the interior of the container. In this case, the closure device, which directly covers the container opening, can be open. The folded-out protective device preferably forms essentially a plane with the lid side surface, which is directed towards the container, i.e. preferably with the underside of the throw-in flap. By means of the protective device, both contamination and damage to the means for irradiation, in particular also during pressing or when the throw-in flap is open, can be avoided.

The present invention further relates to a method for collecting and compacting waste, comprising a) the step of extracting a part of the gaseous atmosphere from a waste bag containing waste, while b) simultaneously mechanically compressing the waste bag and c) simultaneously subjecting the waste bag to external air pressure. According to the invention, therefore, three means for reducing the waste volume are used, firstly, the extraction of the gaseous atmosphere from the waste bag, secondly, mechanical compression, which serves to support the removal of the gaseous atmosphere, and, above all, allows higher pressures to be applied to the waste, since only the pressure of the air column of 1 bar (105 Pa) acts during extraction, and finally, thirdly, the effect of compressed air on the exterior of the waste bag. The latter thus enables pressing from “all directions”. According to the invention, these measures a), b) and c) are carried out simultaneously at least at one point in time during the method.

The pressures used in method steps a), b) and c) preferably correspond to those provided for the device described above. Thus, in step a), a negative pressure of preferably at least 5.0*10⁴ Pa (50 kPa, 500 mbar) absolute pressure, preferably at least 2.0*10⁴ Pa (20 kPa, 200 mbar) absolute pressure, is generated. In step b), the waste bag is preferably subjected to a compressive force of from about 50 kPa to about 1000 kPa, more preferably from about 100 kPa to about 800 kPa, in particular from about 300 kPa to about 600 kPa. In step c), the waste bag is preferably subjected to compressed air of at least 1.0*10⁵ Pa (100 kPa, 1 bar) overpressure, preferably at least 2.0*10⁵ Pa (200 kPa, 2 bar) overpressure. The device according to the invention is preferably configured to facilitate these pressures for steps a), b) and c), in particular simultaneously.

In the method according to the invention, prior to steps a), b) and c) of simultaneously extracting, mechanically pressing and subjecting the waste bag to air pressure, i.e. prior to the step of extracting a part of the gaseous atmosphere from a waste bag containing waste, while simultaneously mechanically compressing the waste bag and subjecting the waste bag to external air pressure, a step is preferably first performed in which only the waste bag is mechanically compressed, preferably followed by the additional extraction of a first part of the gaseous atmosphere from a waste bag, i.e. without subjecting the waste bag to compressed air. According to the invention, the waste bag is preferably first mechanically compressed, then preferably additionally extracted, before the waste bag is most preferably also subjected to air pressure.

In the method according to the invention, before the step of extracting a part of the gaseous atmosphere from a waste bag containing waste, while simultaneously mechanically compressing the waste bag and subjecting the waste bag to external air pressure, the waste bag is preferably closed and sealed by means of a “part of the waste bag or a separate part of the waste bag” (sometimes also referred to only as “part”) by pressing on the part. Since no more air can escape from the waste bag, the cover is perforated at one point as described above. The gaseous atmosphere can now escape through the perforation opening and, optionally, a part of the gaseous atmosphere can be extracted from the waste bag.

The reduction of the waste volume according to the invention by pressing and extraction is typically followed by a step of closing the waste bag by thermal welding to the cover, preferably during or (immediately) after the extraction of a part of the gaseous atmosphere from the waste bag According to the invention, as described in detail above, the device according to the invention is advantageously used for the method according to the invention. Therefore, the method according to the invention is carried out using the device according to the invention as described above. In particular, the movable bottom plate allows the waste bag to be mechanically compressed, being displaceable with respect to the side walls in the direction of the lid, which is in the closed position, allowing for the volume of the container to be reduced. A part of the gaseous atmosphere is then extracted from a waste bag containing waste through the lid device, preferably while maintaining the mechanical pressure by means of the bottom plate. Finally, compressed air, which is provided by the means for generating compressed air, is pressed in through the inlet opening of the container, for example in a controlled manner by means of an inlet valve, preferably while maintaining the pressure by means of the bottom plate and/or while maintaining the extraction, so that the waste bag is additionally compressed. The maximum compression of the waste is thereby achieved. Eventually, the waste can be sealed in the waste bag and disposed of.

### BRIEF DESCRIPTION OF THE FIGURES

The invention will now be described using drawings.

FIG. 1 shows a schematic view of a device according to the invention.

FIG. 2 shows a schematic view of a device according to the invention with the lid device partially opened.

FIG. 3 shows a schematic view of a device according to the invention with containers extended.

FIG. 4 shows a schematic view of two containers of a device according to the invention.

FIG. 5 shows a schematic view of two containers of a device according to the invention with the clamping frame open.

FIG. 6 shows a schematic view of the rear side of two containers of a device according to the invention.

FIG. 7 shows a detailed view of two containers of a device according to the invention.

FIG. 8 shows a schematic view of two containers of a device according to the invention without a side wall of the container.

FIG. 9 shows a schematic view of two containers of a device according to the invention without a side wall of the container and without a bottom plate.

FIG. 10 shows a schematic view of two containers of a device according to the invention without a side wall of the container with the means for displacing the bottom plate extended.

FIG. 11 shows a schematic view of two containers of a device according to the invention without a side wall of the container with extended means for displacing the bottom plate without a bottom plate.

FIG. 12 shows a schematic view of two lids of a device according to the invention in the extended state.

FIG. 13 shows a detailed view of two lids of a device according to the invention.

FIG. 14 shows a detailed view of two lids of a device according to the invention from the rear.

FIG. 15 shows a top view of a device according to the invention.

FIG. 16 shows a section A-A as indicated in FIG. 15.

FIG. 17 shows a section A-A as indicated in FIG. 15 for an alternative embodiment.

FIG. 18 shows a detailed view B of section A-A as indicated in FIG. 16 and FIG. 17.

FIG. 19 shows a detailed view C of section A-A as indicated in FIG. 16 and FIG. 17.

FIG. 20 shows a detailed view B of section A-A as indicated in FIG. 16 and FIG. 17.

FIG. 21 shows a detailed view C of section A-A as indicated in FIG. 16 and FIG. 17.

FIG. 22 shows a detailed view of two containers of a device according to the invention.

FIG. 23 shows a detailed view of two containers of a device according to the invention.

FIG. 24 shows a cross-section of the device of FIG. 23 according to the invention.

FIG. 25 shows a detailed view of FIG. 24.

FIG. 26 shows a detailed view of FIG. 24.

FIG. 27 shows three schematic views of a device according to the invention with closed throw-in flap (A), opened throw-in flap (B) and partially opened lid device (C).

FIG. 28 shows a schematic view of a device according to the invention with extended container.

FIG. 29 shows a section through a device according to the invention.

FIG. 30 shows the detailed views A and B of FIG. 29.

### DETAILED DESCRIPTION

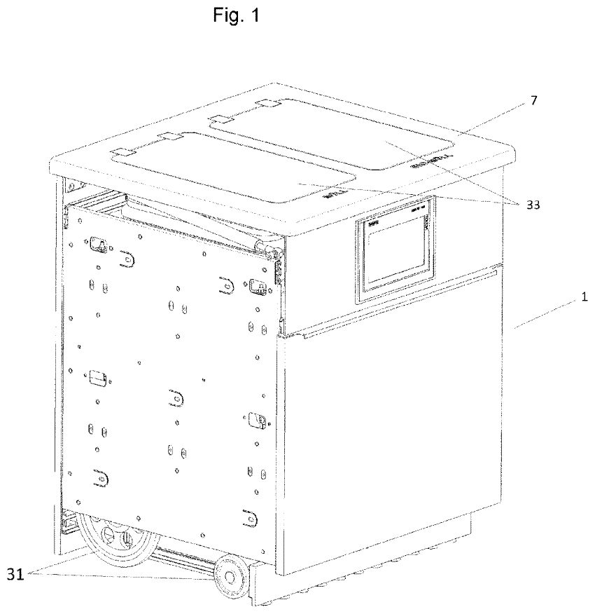

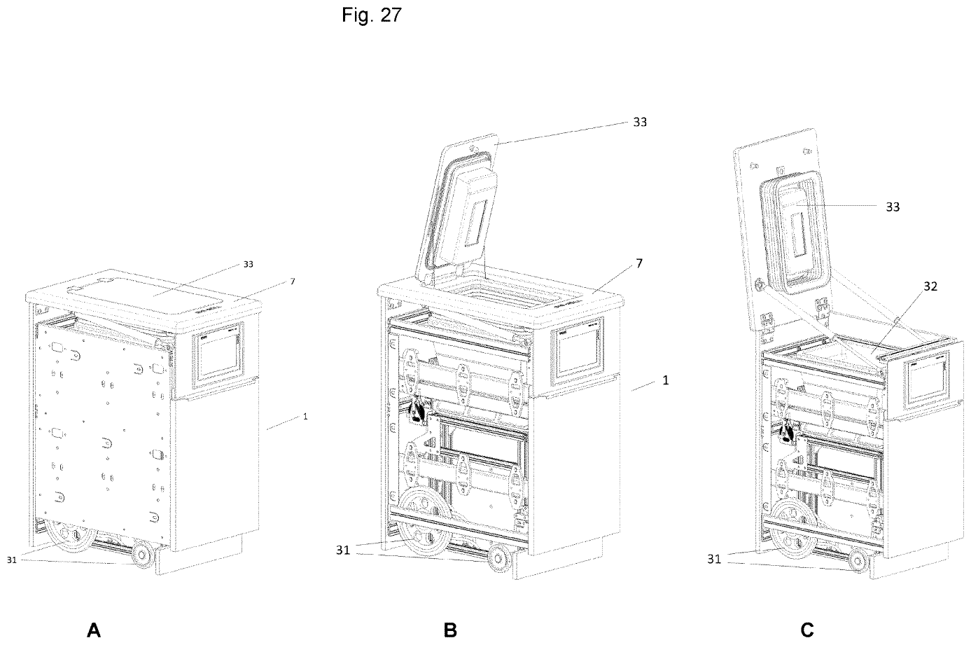

A device (1) according to the invention is shown in FIG. 1, embodied here with two throw-in flaps (33) in the lid device (7) for two separate containers, with front cover, operating element (embodied as a touch screen) and skirting board, e.g. suitable as a mobile, free-standing waste bin. The left side cover is not shown, which allows a view of the means for displacing the device (31), here in the form of wheels. The device is preferably designed in such a way that the throw-in flaps (33) open, for example by tapping or touching the control panel, in order to open access to the containers with waste bags inside for the insertion of the waste. The throw-in flaps (33) may be opened using corresponding hinges, as illustrated in FIG. 27 B. The throw-in flaps (33) can be reclosed manually or automatically, again, for example, by tapping or touching the control panel.

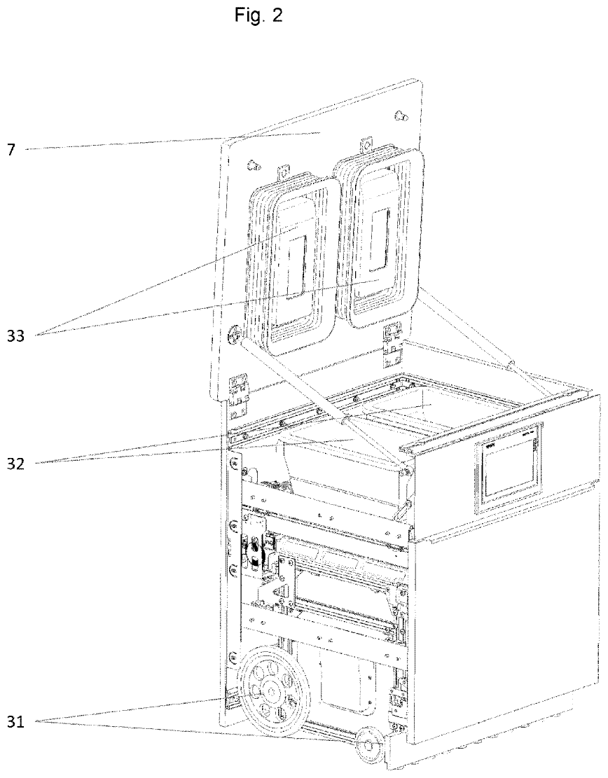

FIG. 2 shows a device (1) according to the invention with a partially open lid device (7), here also designed as a free-standing waste bin rendered mobile due to the means for displacing the device (31) with front cover and skirting board. The possibility of opening the cover plate together with the throw-in flaps (33) separately from the throw-in funnels (32) (for example by means of suitable hinges) and thus separating the latter components results in advantageous access to the components for service and cleaning.

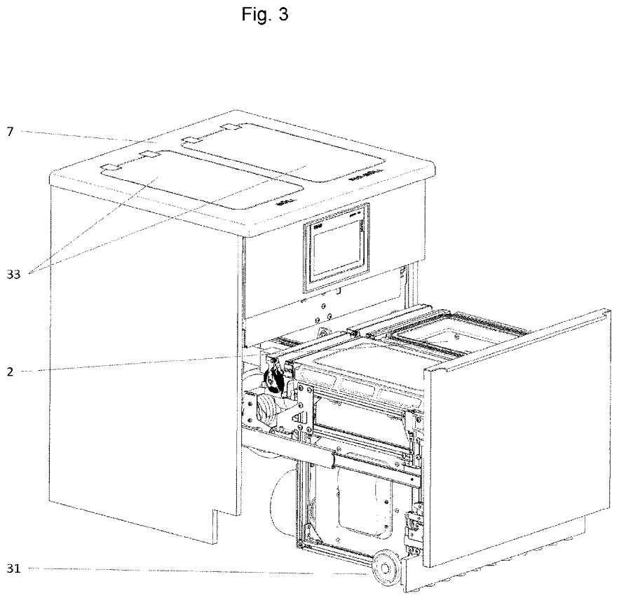

FIG. 3 shows a device (1) according to the invention as shown in FIG. 1. The middle part, which comprises the container unit, is shown pulled out by means of the side pull-out rails. The upper part with the operating element comprising the lid device is shown in the folded state. The container unit comprises two containers (2). In the embodiment with throw-in flaps (33), the middle part can be extended, for example, to cover the waste bags for welding, to remove the welded waste bag, or to insert an empty waste bag into the container (2). In this embodiment, the waste bag is normally filled by opening the throw-in flaps (33) when the middle part is retracted.

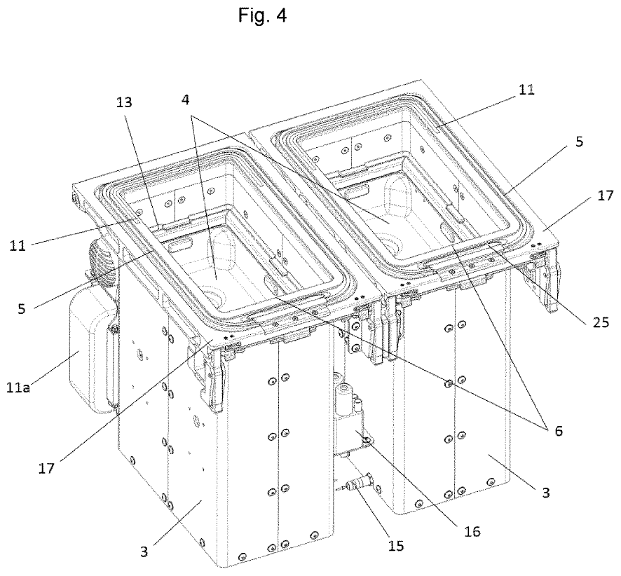

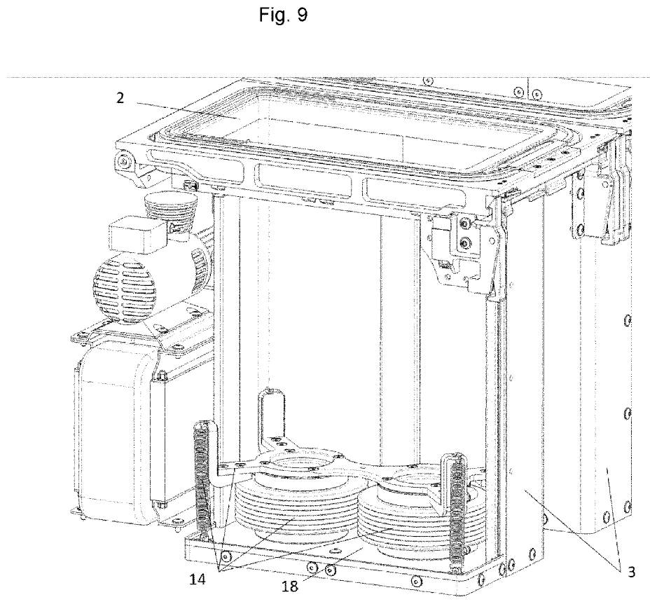

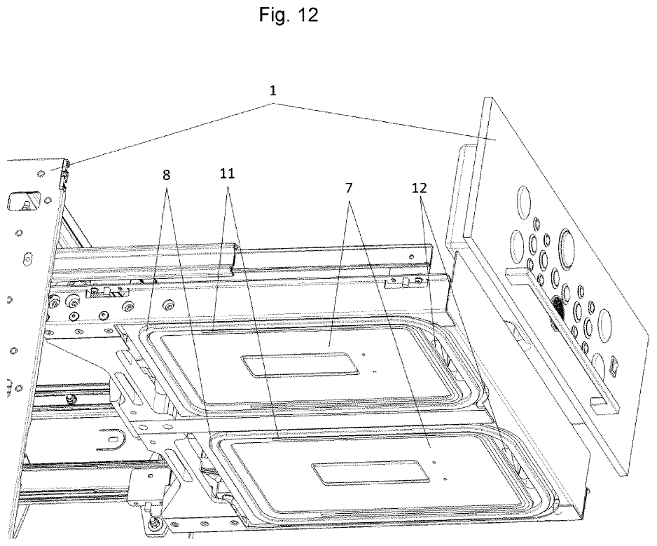

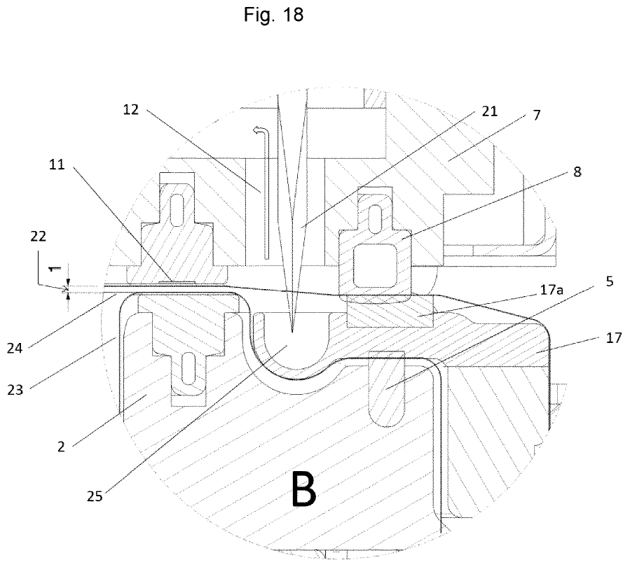

FIG. 4 shows a detailed view of the containers of the device (1) according to the invention. The containers are essentially formed from the side walls (3) and the container bottom (not visible here). Inside the containers is the displaceable bottom plate (4). The first seal (5) is provided at the opening (6) of each container. The means for thermal welding (11) are designed as strip electrodes at the openings (6), but in this case only about one third of the way around the openings (6). The corresponding electrodes on the lid device, not shown here (see FIG. 12), complete the means for thermal welding (11) for complete circulation around the openings. This ensures the complete sealing of the waste bag during welding. Alternatively, the strip electrodes can also be designed fully circumferentially around the container opening. The controller for the means for thermal welding (11a) supplies the means for thermal welding (11) at the opening (6) or the lid device (7). The seal on the bottom plate (13) (also referred to as the “third seal”) seals the bottom plate (4) in an airtight manner with respect to the side walls (3) in any position of the bottom plate, in an embodiment described in detail above, preferably at least to prevent dirt from getting under the bottom plate (4). When the opening (6) of the container is closed, it is therefore closed through the side walls (3) (these are also airtight) and hermetically sealed either through the bottom plate (4), or at least through the container bottom (18) (not shown here, see e.g. FIG. 9). Via the controlled inlet valve for compressed air (16), compressed air can enter the interior of the container through the inlet opening (15). This compressed air is used to compress the waste in the waste bag arranged inside the container (and above the bottom plate) when the lid device is in the closed position and presses the waste bag against the first seal (5). In the event that the seal (13) is designed to be airtight, the compressed air is introduced into the interior of the container above the bottom plate. The fixing means (17), here embodied as a clamping frame and shown in the closed state, encloses the opening (6) on the outside and, when a waste bag (not shown here) is inserted (when the clamping frame is open), can clamp it and thus fix it to the container. The fixing means (17) only partially covers the first seal (5), here at the end of the opening (6) shown at the front in the figure. In this area, the fixing means (17), according to a preferred embodiment of the present invention, serves to form a recess for perforation (25). A waste bag inserted when the clamping frame (17) is open is clamped over the first seal (5) by means of the clamping frame. Without the recess for perforation (25), which is preferably formed by the clamping frame while covering the first seal (5), when the waste bag is covered for welding, the cover (a part of the waste bag or a separate part) and the waste bag would lie directly on top of each other, so that only the cover could not be perforated by the perforation means (21), or only selectively under certain circumstances. The recess for perforation (25) thus protects the waste bag from the perforation means (21), the latter can only perforate the cover in order to allow the gaseous atmosphere to be extracted and/or the gaseous atmosphere to escape from the interior of the waste bag. This is described in more detail in FIG. 18.

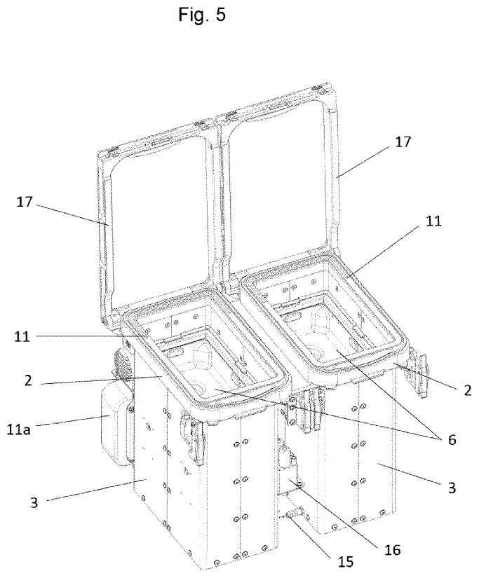

FIG. 5 shows a detailed view of the containers (2) of the device (1) according to the invention according to FIG. 4, only the fixing means (17), here embodied as a clamping frame, is shown in the open state. In this state, a waste bag (not shown here) may be inserted into the interior of the container through the opening (6).

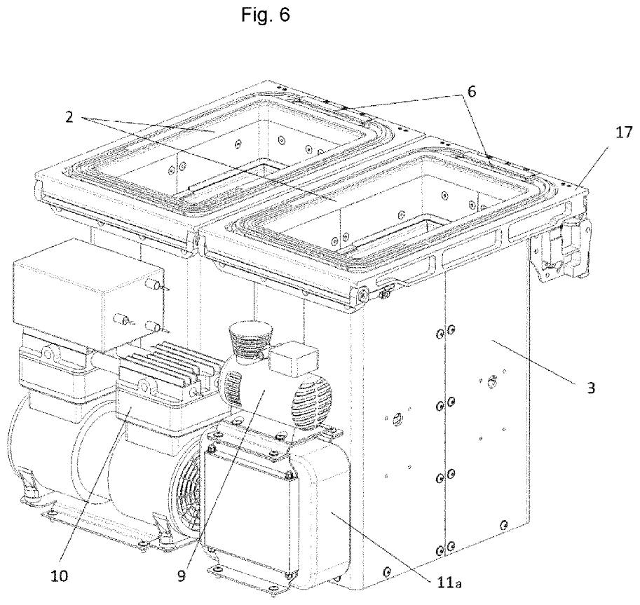

FIG. 6 shows a detailed view of the containers (2) of the device (1) according to the invention from the rear. The containers (2) comprise the side walls (3) and the container bottom (not visible here) and have the openings (6). The fixing means (17), here embodied as a clamping frame and shown in the closed state, encloses the opening (6) on the outside and, when a waste bag (not shown here) is inserted (when the clamping frame is open), can clamp it and thus fix it to the container. To advantageously utilize the space in the device (1) according to the invention, the means (9) for generating compressed air, indicated here as a compressor, and the means (10) for generating negative pressure, indicated here as a vacuum pump, are arranged in the container unit of the device behind the containers. Alternatively, according to the invention, both components, i.e. the means (9) for generating compressed air, e.g. a compressor, and the means (10) for generating negative pressure, e.g. a vacuum pump, can be realized in one component, e.g. in the form of a diaphragm pump, which can deliver both negative pressure and positive pressure. The activated carbon filter (19) is mounted above the vacuum pump here. The controller for the means for thermal welding (11a) is arranged below the compressor.

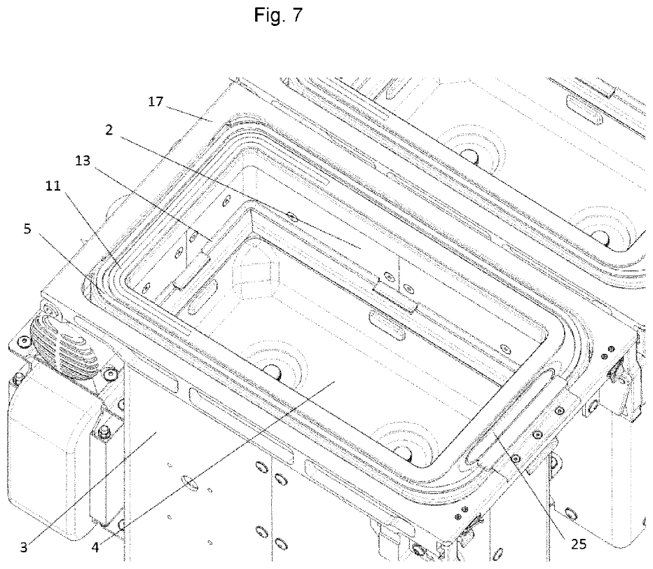

FIG. 7 shows a detailed view of the interior of a container (2) of the device (1) according to the invention. The region of the container (2) in which the waste bag can extend is delimited by the side walls (3) and the displaceable bottom plate (4), shown here in the “raised” state. The first seal (5) and the means for thermal welding (11) are provided at the opening (6) of the container. The seal on the bottom plate (13) seals the bottom plate (4) with respect to the side walls (3), either in an airtight manner, preferably at least to prevent dirt from getting under the bottom plate (4). The fixing means (17) only partially covers the first seal (5), here at the end of the opening shown at the front in the figure. In this area, according to a preferred embodiment of the present invention, the fixing means (17) also serves to form the recess for perforation (25).

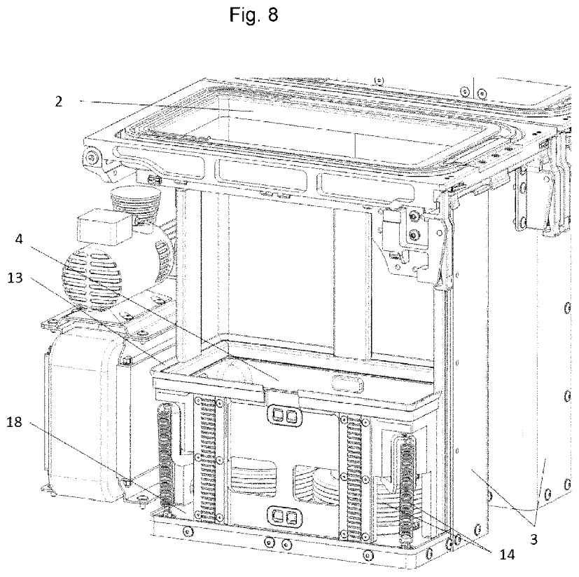

FIG. 8 shows a detailed view of the interior of a container (2) of the device (1) according to the invention. The containers are essentially formed from the side walls (3) (front side wall is not shown) and the container bottom (18). The region of the container (2) in which the waste bag can extend is delimited by the side walls (3) and the displaceable bottom plate (4), shown here in the “lowered” state. The seal on the bottom plate (13) seals the bottom plate (4) with respect to the side walls (3), either in an airtight manner, preferably at least to prevent dirt from getting under the bottom plate (4). According to the invention, the means for displacing the bottom plate (14) preferably comprises both propulsion elements, in this case designed as air bellows, which can displace the bottom plate (4) in the direction of the lid, and return elements, in this case designed as spiral springs.

FIG. 9 shows a detailed view of the interior of a container (2) of the device (1) according to the invention corresponding to FIG. 8. The containers are essentially formed from the side walls (3) (front side wall is not shown) and the container bottom (18). The bottom plate (4) is not shown compared to FIG. 8. According to the invention, the means for displacing the bottom plate (14), shown here in the “lowered” state, preferably comprise both propulsion elements, in this case designed as air bellows, which are connected by means of a holder and can displace the bottom plate (4) in the direction of the lid, and return elements, in this case designed as spiral springs.

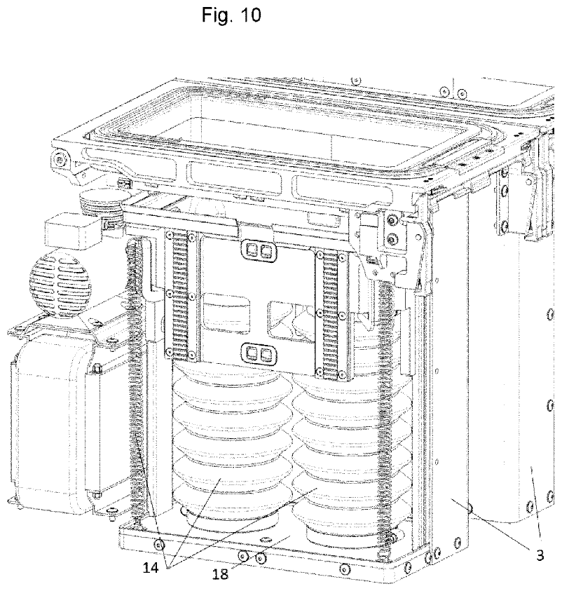

FIG. 10 shows a detailed view of the interior of a container of the device (1) according to the invention corresponding to FIG. 8, but the displaceable bottom plate (4) is brought into the “raised” state by the means for displacing the bottom plate (14). According to the invention, the means for displacing the bottom plate (14) preferably comprises both propulsion elements, in this case designed as air bellows, which can displace the bottom plate (4) in the direction of the lid, and return elements, in this case designed as spiral springs. The latter are clamped in the “raised” state and allow the bottom plate to be reset, for example after emptying the container, i.e. after removing the pressed and welded waste bag.

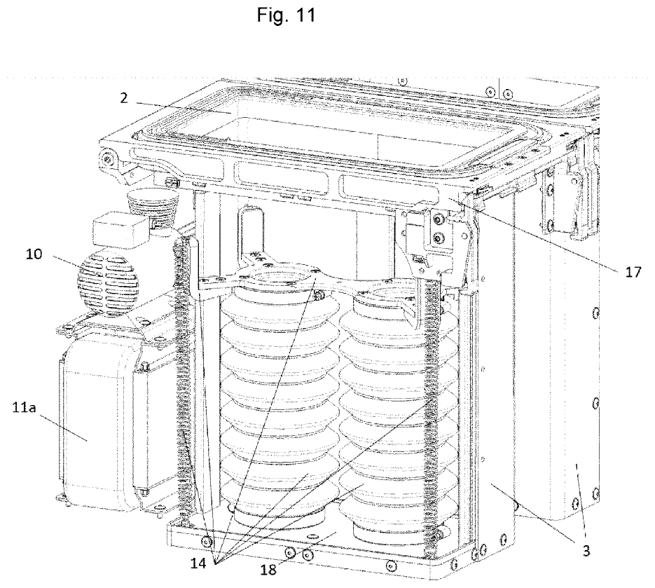

FIG. 11 shows a detailed view of the interior of a container (2) of the device (1) according to the invention corresponding to FIG. 10. The means for displacing the bottom plate (14) is shown in the “raised” state, the bottom plate is not shown.

FIG. 12 shows a detailed view of the lid device (7) of the device (1) according to the invention, here in the extended state (e.g. for service purposes) by means of pull-out rails. In the embodiment shown (described here as a second embodiment), the throw-in flaps are directly above the container opening and serve as rigid lids of the lid device. Once the containers are retracted, a throw-in funnel is not present. The lid device (7) comprises the second seal (8), which interacts with the first seal (5) at the container opening (not shown here) in the closed position. The means for thermal welding (11) are designed as strip electrodes, but only about two thirds of the way around the opening. The corresponding electrodes at the container opening, not shown here (see e.g. FIG. 4), complete the means for thermal welding (11) for complete circulation around the opening of the container. This ensures the complete sealing of the waste bag during welding. The atmosphere can be extracted from the waste bag from the suction openings (12).

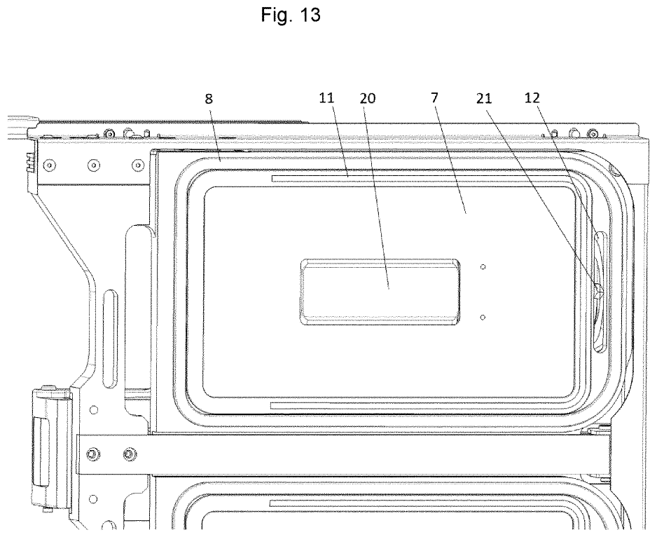

FIG. 13 shows a detailed view of the lid device (7) of the device (1) according to the invention in the embodiment according to FIG. 12, shown here from below from the direction of the containers. In the embodiment shown, the throw-in flaps are directly above the container opening, a throw-in funnel is not present. The lid device (7) comprises the second seal (8), which interacts with the first seal (5) at the container opening (not shown here) in the closed position. The means for thermal welding (11) are designed as strip electrodes, but only about two thirds of the way around the opening. The atmosphere can be extracted from the waste bag through the suction opening (12). The suction opening (12) also houses the perforation means (21). The protective device (20) can be folded away in operation, thereby allowing optical access for the means for irradiation, typically a UV lamp, to the interior of the container. The light from the UV lamp can thus reach the interior of the container as soon as the protective device (20) has been moved aside, e.g. rotated or pushed. In the closed state, the protective device (20) essentially forms a plane with the side surface of the lid device (7), which is directed towards the container in the closed position.

In the embodiment shown, in which the throw-in flaps are directly above the container opening, and a throw-in funnel is not present, the lid device (7) of the device (1) according to the invention remains in the retracted state during normal operation of the device, as in FIG. 1. In this embodiment, to introduce waste into the waste bag, the container unit is typically extended as shown in FIG. 3, and retracted again as shown in FIG. 1 after introducing the waste. In the retracted state, the second seal (8) is normally lowered, so that the second seal (8) interacts with the first seal (5) at the container opening in the closed position, and seals the waste bag. In this way, an odor caused by the waste is avoided; in addition, the waste can be irradiated with UV light after the container unit has been retracted by the means for irradiating the interior of the container. In one embodiment, each time the container unit is retracted after the waste has been introduced, it is irradiated and/or a portion of the atmosphere is extracted from the waste bag.

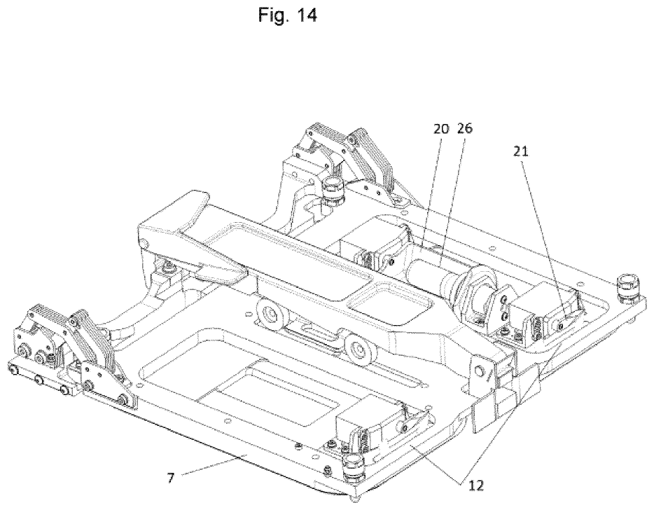

FIG. 14 shows a detailed view of the lid device (7) of the device (1) according to the invention, shown here from above and in the embodiment in which the throw-in flaps are directly above the container opening, and a throw-in funnel is not present. The atmosphere can be extracted from the waste bag through the suction opening (12). The housing, which normally encloses the suction opening, the UV lamp (26) and the protective device (20), is not shown. The waste bag can be perforated through the suction opening (12) by the perforation means (21), here illustrated as a blade, which traverses a semicircular cutting area. In the case of the lid shown in the foreground, the UV lamp (26) and the protective device (20) are not visible; only the opening normally filled by the protective device (20) is shown.

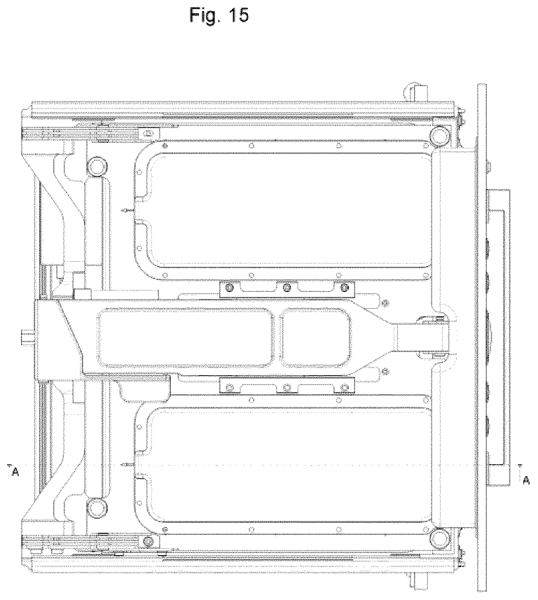

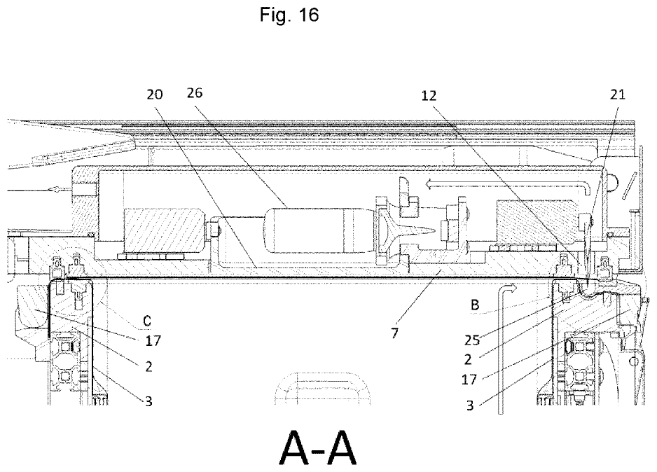

FIG. 15 shows a schematic of the device (1) according to the invention in the embodiment of FIG. 14 from above to illustrate the position of section A-A as shown in FIG. 16.

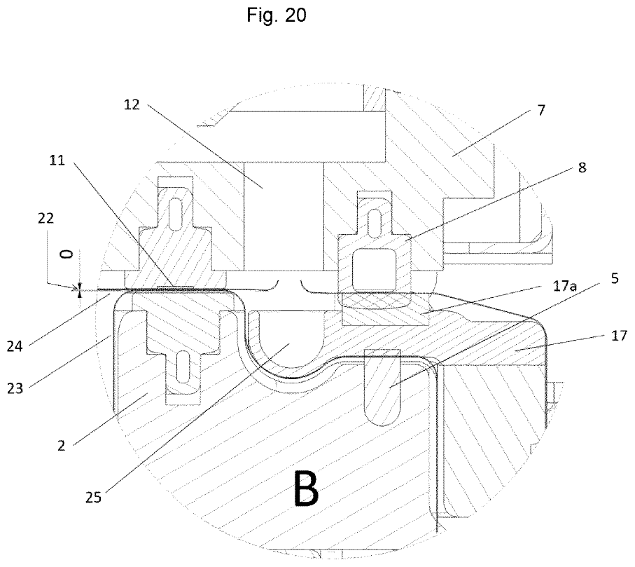

FIG. 16 shows section A-A from FIG. 15. The lid device (7) in the embodiment in which the throw-in flaps are directly above the container opening, and a throw-in funnel is not present, the UV lamp (26) and the protective device (20), and the container opening are shown. The perforation means (21), here illustrated as a blade, protrudes through the suction opening (12) and perforates the part of the waste bag or the separate part that covers the waste bag. This is explained in more detail in FIGS. 18 and 20, which illustrate detail area B of FIG. 16. The side walls (3), the clamping frame (17) and the opening of the container (2) are shown. Also indicated is the waste bag, as well as the part of the waste bag, or the separate part that covers the waste bag, and thus spans the container opening. This is explained in more detail in FIGS. 18 to 21.

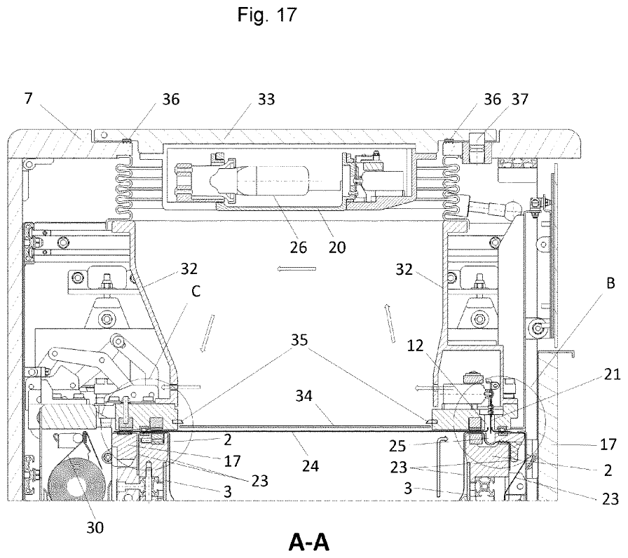

FIG. 17 shows a section A-A corresponding to FIG. 16, but in the (first) embodiment, in which the lid device (7) comprises throw-in flaps (33) and one throw-in funnel (32) per container. The throw-in flap (33) closes the wider, upwardly directed opening of the throw-in funnel (32). With the throw-in flap (33) open, access to the interior of the throw-in funnel (32) and the opening of the container is typically enabled. When the waste bag is inserted, it can thus be filled. In the closed state as shown, the throw-in flap (33) closes the opening of the throw-in funnel (32) in a light-tight manner by means of the (fourth) seal (36). The lid device (7) also has a lock (37) that interacts with the throw-in flap (33) and is capable of reversibly holding the throw-in flap (33) in the closed state. This ensures that the container is securely and tightly closed by the throw-in flap (33).

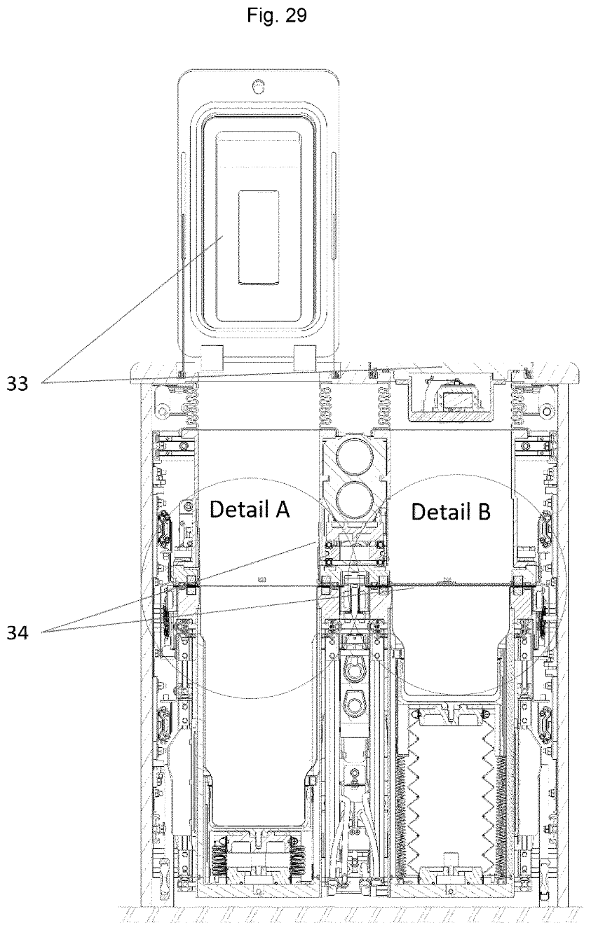

The lid device (7) shown in FIG. 17 comprises a throw-in funnel (32) and, within the funnel, a closure device (34) according to a preferred embodiment. The closure device (34) is configured to essentially close the opening of the throw-in funnel at its tapered end (lower end facing the container opening) with the throw-in flap (32) in the closed state, as shown. If a waste bag (23) is inserted in the container (3) and the latter is covered with a flap of the waste bag or separate part (24) as described above and as shown in FIG. 17, and if the waste is mechanically compressed, it would be pressed into the throw-in funnel (32). The closure device (34) prevents this. The latter is thus closed before the mechanical pressing; optionally, the closure device (34) is always closed as soon as the throw-in flap (33) is closed. In order to reinforce the closure device (34), preferably formed from closure flaps (see FIG. 29), against the mechanical pressure (with which the waste in the container is compressed), locks (35) are provided for the closure device (34). These locks (35) can prevent the closure device (34) from being pushed open by the mechanical pressure.

In the embodiment shown in FIG. 17, the throw-in flap (33) also comprises the means for irradiation (26), typically a UV lamp, and the protective device (20).

The latter can be folded away in operation, thereby allowing optical access for the means for irradiation to the interior of the container. The light from the UV lamp can thus reach the interior of the container as soon as the protective device (20) has been moved aside, e.g. rotated or pushed, and the closure device (34) is opened.

In FIG. 17, arrows illustrate the path of the atmosphere when it is removed from the waste bag. In the embodiment shown, the atmosphere is extracted through the suction gap (see detail FIG. 18) through the suction opening (12) and through the filling funnel (32), in which there is an opening with a connection to the means for generating negative pressure (in FIG. 17, bottom left in the filling funnel (32)).

FIG. 18 shows detail area B from FIGS. 16 and 17 with more details to illustrate the step of perforating and extraction. Detail area B shows the upper edge of the container (2) with the first seal (5) at the opening of the container. The lid device (7) is shown in the closed position, and the second seal (8) on the lid device interacts with the first seal (5), in this case via a part of the clamping frame (17), including a corresponding further seal on the clamping frame (17a). The means for thermal welding (11) are arranged on the lid device, here designed as strip electrodes. A waste bag (23) is shown inserted in the container and rests against the side wall (3) within the container. By means of the means for fixing the waste bag (17), here embodied as a clamping frame, the waste bag is clamped over the container opening, in particular over the first seal (5) at the opening of the container. In the case of detail area B, the clamping frame (17) presses the waste bag (23) directly onto the first seal (5), since here the clamping frame (17), including the further seal on the clamping frame (17a), projects beyond the first seal (5). For areas where the means for fixing the waste bag (17) does not project beyond the first seal (5), such as shown in FIG. 4 and discussed with respect to FIG. 4, the means for fixing the waste bag (17) only clamps the waste bag over the first seal (5). In order to close the waste bag when the intended fill level is reached, according to the invention, a part, for example a flap of the waste bag, or, preferably, a separate part of the waste bag (24), for example from an endless roller, must be placed over the container opening. This is typically done manually with the container unit pulled out, but corresponding means can also be provided that automatically position the separate part, for example a flap of the waste bag, or, preferably, a separate part (24), for example from an endless roller, over the container opening. This may also be provided for the container unit in the retracted state, as shown in FIG. 1. After the container unit has been inserted into the device (1) according to the invention, which can be provided and carried out manually or automatically, e.g. at the push of a button, the lid device is brought into the closed position, as shown in FIG. 18. In this case, the second seal (8) of the lid device is pressed onto the clamping frame (17), including a corresponding further seal (17a), and the latter is pressed onto the first seal (5). For areas where the clamping frame does not project beyond the first seal (5), such as shown in FIG. 4 and discussed with respect to FIG. 4, the clamping frame only clamps the waste bag over the first seal (5). In this case, the second seal (8) of the lid device is pressed directly onto the first seal (5). In both cases, the second seal (8) of the lid device seals the part of the waste bag, for example a flap of the waste bag, or, preferably, the separate part (24) against the waste bag (23). In this position, the interior of the waste bag is hermetically sealed from the environment. However, this also means that the atmosphere could not be extracted from the interior of the waste bag in this state, or the atmosphere could not escape from the interior of the waste bag when the waste bag is compressed. To make this possible, the perforation means (24) creates a defined opening in the cover of the waste bag. The recess for perforation (25) created by the clamping frame (17) by covering the first seal (5) allows selective perforation of the covering part of the waste bag, for example a flap of the waste bag, or, preferably, of the separate part (24), as shown in FIG. 18. As also shown in detail area B of FIG. 18, the fixing means (17), according to a preferred embodiment of the present invention, serves to form a recess for perforation (25). Without the recess for perforation (25), which is preferably formed by the clamping frame while covering the first seal (5), when the waste bag is covered for welding, the cover (a part of the waste bag or a separate part) and the waste bag would lie directly on top of each other, so that only the cover could not be selectively perforated by the perforation means (21). The recess for perforation (25) thus protects the waste bag from the perforation means (21), the latter can only perforate the cover. After perforation has taken place, a part of the atmosphere can be extracted from the interior of the waste bag through the suction opening (12), as indicated by the arrow, or a part of the atmosphere can escape from the interior of the waste bag during the pressing thereof, namely through the suction gap (22), which remains between the waste bag (23) and the covering part of the waste bag, for example a flap of the waste bag, or, preferably, of the separate part (24).

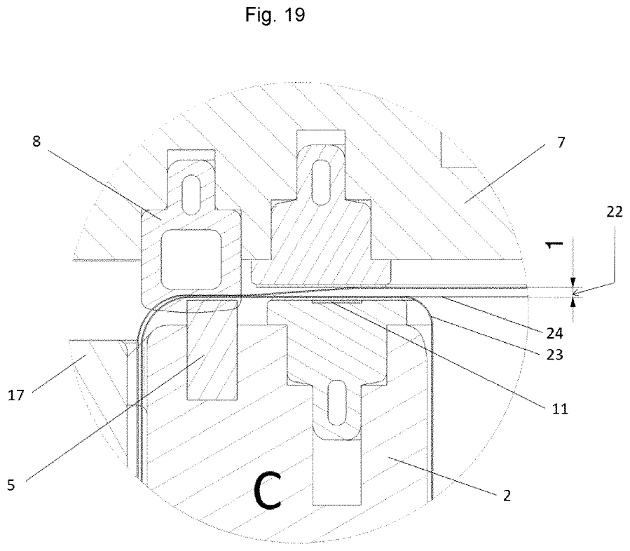

FIG. 19 shows detail area C from FIGS. 16 and 17 with more details according to the step of perforating and extraction as in FIG. 18. Detail area C shows the upper edge of the container (2) with the first seal (5) at the opening of the container. The lid device (7) is shown in the closed position, and the second seal (8) on the lid interacts with the first seal (5). The means for thermal welding (11) are arranged on the container, here designed as strip electrodes. A waste bag (23) is inserted in the container and rests against the side wall (3) within the container. By means of the means for fixing the waste bag (17), here embodied as a clamping frame, the waste bag is clamped over the container opening, in particular over the first seal (5) at the opening of the container. In order to close the waste bag, according to the invention, a part, for example a flap of the waste bag, or, preferably, a separate part of the waste bag (24), for example from an endless roller, must be placed over the container opening. As shown in FIG. 19, corresponding to FIG. 18, the lid device is brought into the closed position. In this case, the second seal (8) of the lid device is pressed onto the first seal (5), and the second seal (8) of the lid device seals the part of the waste bag, for example a flap of the waste bag, or, preferably, the separate part (24) against the waste bag (23). In this position, the interior of the waste bag is hermetically sealed from the environment. Between the welding means (11) and the corresponding opposing surface, the suction gap (22) remains between the waste bag (23) and the covering part of the waste bag, for example a flap of the waste bag, or, preferably, of the separate part (24).

FIG. 20 shows detail area B from FIGS. 16 and 17 with more details for the welding step. As shown in FIG. 18, the lid device is also shown in the closed position but lowered further to allow for the welding of the waste bag. In this case, the lid device is displaced further towards the upper edge of the container (2) with the first seal (5), and the second seal (8) on the lid continues to interact with the first seal (5), in this case via a part of the clamping frame (17), including a corresponding further seal (17a). The means for thermal welding (11) arranged on lid device, here designed as strip electrodes, now rest directly on the corresponding opposing surface of the container opening and the suction gap (22) still present in FIG. 18 is closed. The waste bag (23) inserted in the container is thus in contact with the part, for example a flap of the waste bag, or, preferably, a separate part of the waste bag (24), for example from an endless roller, below the means for thermal welding (11) and can be welded to this and thus sealed.

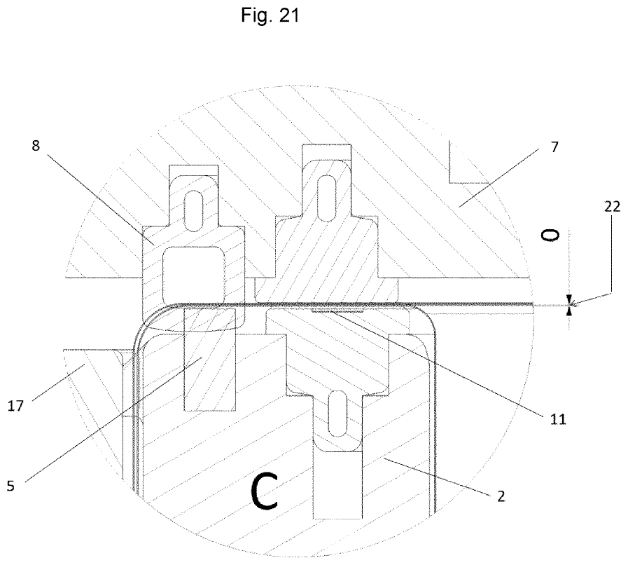

FIG. 21 shows detail area B from FIGS. 16 and 17 with more details for the welding step. Compared to FIG. 19, the lid is also in the closed position but lowered further to allow for the welding of the waste bag. In this case, the lid device is displaced further towards the upper edge of the container (2) with the first seal (5), and the second seal (8) on the lid continues to interact with the first seal (5), in this case via a part of the clamping frame (17), including a corresponding further seal (17a). The means for thermal welding (11) arranged on the container (2), here designed as strip electrodes, are now in direct contact with the corresponding opposing surface of the lid device and the suction gap (22) still present in FIG. 19 is closed. The waste bag (23) inserted in the container is thus in contact with the part, for example a flap of the waste bag, or, preferably, a separate part of the waste bag (24), for example from an endless roller, above the means for thermal welding (11) and can be welded to this and thus sealed.

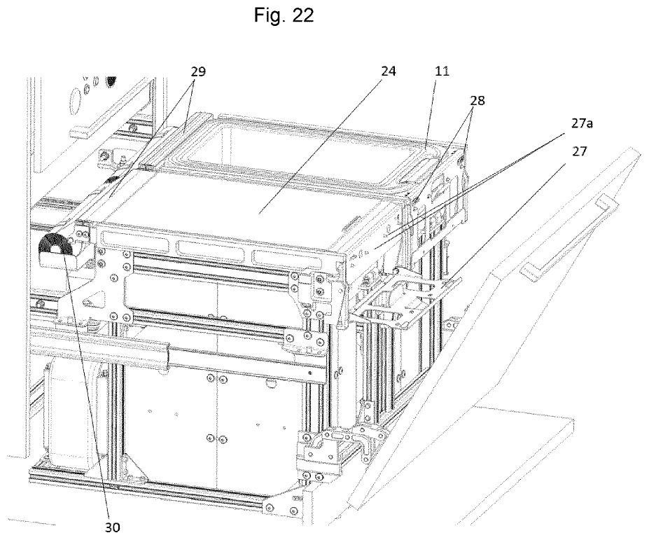

FIG. 22 shows a detail area corresponding to the second embodiment of the device according to the invention. The pull-out middle part, fixed by the side pull-out rails, comprises the container unit, here two containers, shown in the pulled-out state with the front cover slightly folded down. In the embodiment shown, the means for thermal welding (11) are designed to be fully circumferential at the opening of the container, which is preferred according to the invention. In the container shown in the foreground, the opening of the container is covered by a separate part of the waste bag (24) and thus shown closed. The separate part of the waste bag (24) comes from a roller (30) (endless roller), as shown in FIG. 22, which stores several parts of the waste bag (24) provided for covering the waste bag. The roller (30) is preferably arranged at the rear end of the containers, i.e. at the end of the container further away from the front cover. As in the state shown in FIG. 22, the roller (30) is thus preferably arranged in such a way that, in order to close the waste bag, according to the invention, a separate part of the waste bag (24) can be unrolled from the roller (30) and placed over the container opening. The part of the waste bag (24) can then be fixed by the means for fixing the cover of the waste bag (27), here designed as a foldable frame on the front side of the container. In this case, the means for fixing the cover of the waste bag (27) of the part of the waste bag (24) preferably presses on spikes for fixing the cover of the waste bag (27a). Typically, means for separating (29), here embodied as a cutting electrode, are provided between the roller (30) and the opening of the container. Alternatively, the means for separating (29) can also be embodied as a tear edge. Preferably, safety switches (28) are arranged such that they are activated when the part of the waste bag (24) is correctly placed on the opening of the container. This arrangement makes it possible that as soon as the part of the waste bag (24) that will close the waste bag is placed over the opening of the container, the part (24) can be fixed by the means for fixing the cover of the waste bag (27), wherein the safety switches (28) are activated when the part (24) is correctly placed on the opening of the container. Subsequently, the waste bag can be welded and thus closed in a fully circumferential manner at the opening of the container by the means for thermal welding (11) and, preferably after welding the waste bag, the part (24) can be separated from the roller (30) by the means for separating (29). Finally, after opening the means for fixing the cover (27) and the means for fixing the waste bag (17), the welded waste bag can be removed from the container.

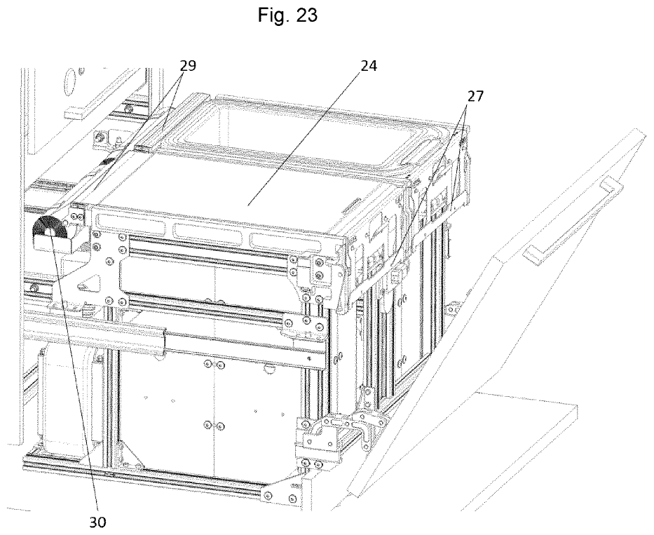

FIG. 23 shows the detail area of a preferred device according to the invention corresponding to FIG. 22. In the container shown in the foreground, the opening of the container is covered by a separate part of the waste bag (24) and shown closed. In comparison to FIG. 21, the means for fixing the cover of the waste bag (27), here designed as a foldable frame on the front side of the container, is shown closed. The part of the waste bag (24) is thus fixed. In this case, the means for fixing the cover of the waste bag (27) of the part of the waste bag (24) preferably presses on spikes for fixing the cover of the waste bag (27a) and activates the safety switches (28) (not shown here).

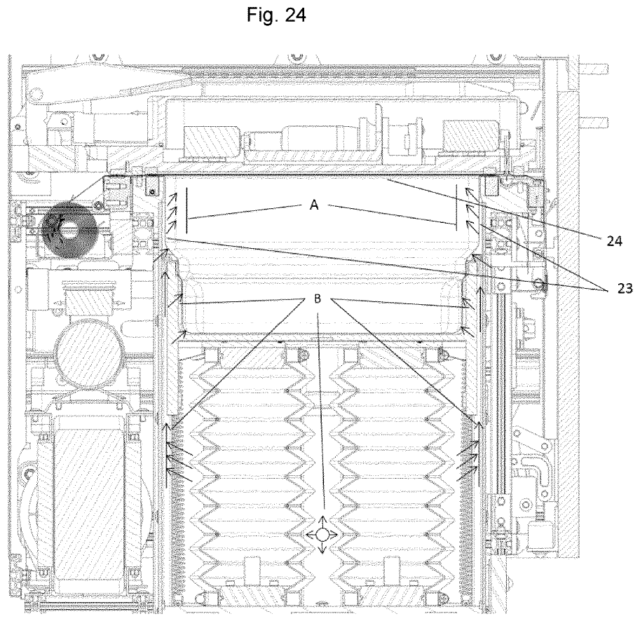

FIG. 24 shows a cross-section of a device according to the invention in the embodiment corresponding to FIG. 16. In the container shown, the opening of the container is covered by a separate part of the waste bag (24) and the inserted waste bag (23) is thus shown closed. The separate part of the waste bag (24) comes from a roller (30) (endless roller), as shown in the figure, which stores several parts of the waste bag (24) provided for covering the waste bag. In the method according to the invention, three means are used simultaneously to reduce the waste volume: firstly, the extraction of the gaseous atmosphere from the waste bag; secondly, mechanical compression, which serves to support the removal of the gaseous atmosphere; and, above all, allows higher pressures to be applied to the waste, and finally, thirdly, the effect of compressed air on the exterior of the waste bag. The extraction of the gaseous atmosphere from the waste bag, which generates a negative pressure in the waste bag, is shown in the figure as “A”. The pressurization is illustrated by the arrows marked with “B”. The latter is brought about by introducing compressed air into the container, here below the bottom plate. The compressed air flows past the seals of the bottom plate and acts on the waste bag, which is sealed against the lid. The force due to the lifting of the bottom plate brings about the mechanical pressing of the waste.

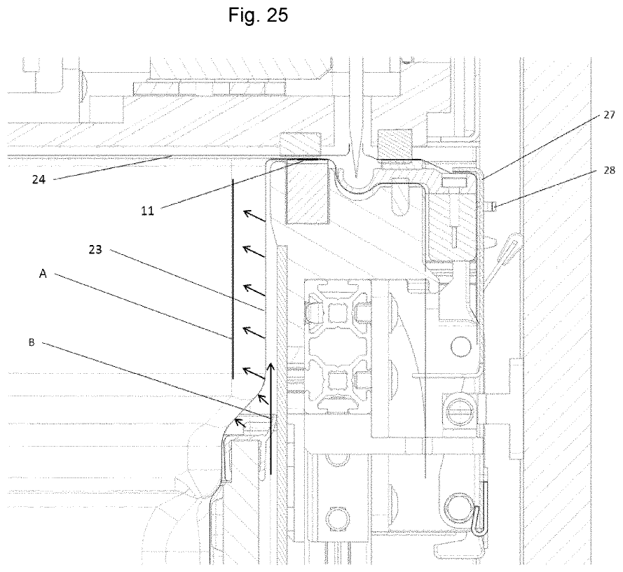

FIG. 25 shows a detail area corresponding to FIG. 18 with more details for the step of perforating and extraction as well as the application of air pressure. The upper edge of the container is shown, the lid is in the closed position, and the second seal on the lid interacts with the first seal, in this case via a part of the clamping frame, including a corresponding further seal on the clamping frame (as in FIG. 18). The means for thermal welding (11) are arranged at the container opening, here designed as strip electrodes. A waste bag (23) is shown inserted in the container and rests against the side wall (and the bottom plate, not shown here) within the container. By means of the means for fixing the waste bag, here embodied as a clamping frame, the waste bag is clamped over the container opening. In order to close the waste bag when the intended fill level is reached, according to the invention, a part, for example a flap of the waste bag, or, preferably, a separate part of the waste bag (24), for example from an endless roller, is placed over the container opening. This is typically done manually with the container unit pulled out, but corresponding means can also be provided that automatically position the separate part (24), for example from an endless roller, over the container opening. The separate part of the waste bag (24) is clamped by the means for fixing the cover of the waste bag (27); a correctly inserted part (24) activates the safety switches (28). With the lid in the closed position, the second seal of the lid device is positioned directly on the first seal of the container (see in more detail in FIG. 18). The seals of the lid device and the container seal the separate part (24) against the waste bag (23). In this position, the interior of the waste bag is hermetically sealed from the environment. To make it possible to extract the atmosphere from the interior of the bag, the perforation means creates a defined opening in the cover of the waste bag. After perforation, a part of the atmosphere can be extracted from the interior of the waste bag through the suction opening on the lid, or a part of the atmosphere can escape from the interior of the waste bag during the pressing thereof. The extraction of the gaseous atmosphere from the waste bag, which generates a negative pressure in the waste bag, is shown in the figure as “A”. The pressurization is illustrated by the arrows marked with “B”. The latter is brought about by introducing compressed air into the container, here below the bottom plate. The compressed air flows past the seals of the bottom plate and acts on the waste bag, which is sealed against the lid. The force due to the lifting of the bottom plate brings about the mechanical pressing of the waste.

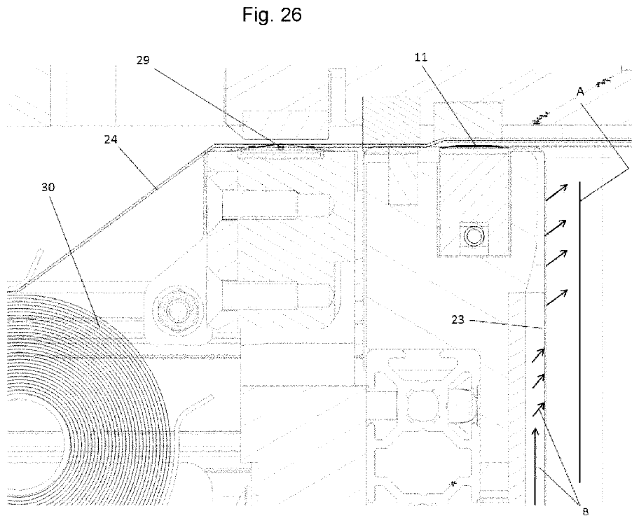

FIG. 26 shows the detail area corresponding to FIG. 25 at the other end of the container, corresponding to FIG. 19. The upper edge of the container is shown. The lid device is in the closed position, and the second seal on the lid device interacts with the first seal (as shown in FIG. 19). The means for thermal welding (11) are arranged at the container opening, here designed as strip electrodes. A waste bag (23) is shown inserted in the container. By means of the means for fixing the waste bag, here embodied as a clamping frame, the waste bag is clamped over the container opening. According to the preferred embodiment shown, a separate part of the waste bag (24) is positioned by a roller (30) over the container opening and the waste bag inserted therein, typically manually with the container unit pulled out, but corresponding means can also be provided that automatically position the separate part (24) over the container opening. The seals of the lid device and the container seal the separate part (24) against the waste bag (23). The extraction of the gaseous atmosphere from the waste bag, which generates a negative pressure in the waste bag, is shown in the figure as “A”. The pressurization is illustrated by the arrows marked with “B”. After extraction, the waste bag is closed by welding to the separate part (24), and the latter is separated from the roller (30) by the means for separating the separate part (29), here embodied as a cutting electrode.

FIG. 27 shows three views of a device (1) according to the invention according to the first embodiment, embodied with a throw-in flap (33) in the lid device (7) for a (single) container, with front cover, operating element (touch screen) and skirting board, e.g. suitable as a mobile, free-standing waste bin. In view A, the throw-in flap (33) in the lid device (7) is closed, in view B, the throw-in flap (33) is open and thus the container can be filled with waste. View C shows the device with the lid device (7) partially open, corresponding to FIG. 2. The possibility of opening the cover plate together with the throw-in flap (33) separately from the throw-in funnel (32) and thus separating the latter components results in advantageous access to the components for service and cleaning. The left side cover of the device is not shown in all three views, which allows a view of the means for displacing the device (31), here in the form of wheels. The device is preferably designed in such a way that the throw-in flap (33) opens, for example by tapping or touching the control panel, in order to open access to the containers with waste bags inside for the insertion of the waste. The throw-in flap (33) can be reclosed manually or automatically, again, for example, by tapping or touching the control panel.

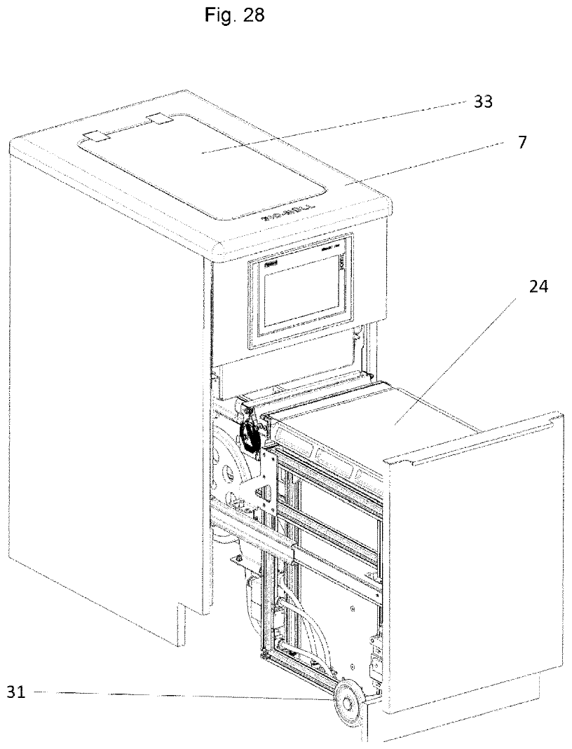

FIG. 28 shows a view of the device (1) according to the invention according to FIG. 27. The middle part, which comprises the container unit, is shown pulled out by means of the side pull-out rails. To increase stability, the means for displacing the device (31), here designed as wheels, are also located on the container unit, i.e. the pulled-out middle part that comprises the containers. The upper part with the operating element comprising the lid device (7) is shown in the folded state with the throw-in flap (33) closed. In the container shown, the opening of the container is covered by a separate part of the waste bag (24) and thus shown closed. The separate part of the waste bag (24) comes from a roller (endless roller), as shown in FIG. 22, which stores several parts of the waste bag (24) provided for covering the waste bag. The roller is preferably arranged at the rear end of the containers, i.e. at the end of the container further away from the front cover. As in the state shown in FIG. 22, the roller (30) is thus preferably arranged in such a way that, in order to close the waste bag, according to the invention, a separate part of the waste bag (24) can be unrolled from the roller and placed over the container opening. The part of the waste bag (24) can then be fixed by the means for fixing the cover of the waste bag, here designed as a foldable frame on the front side of the container.

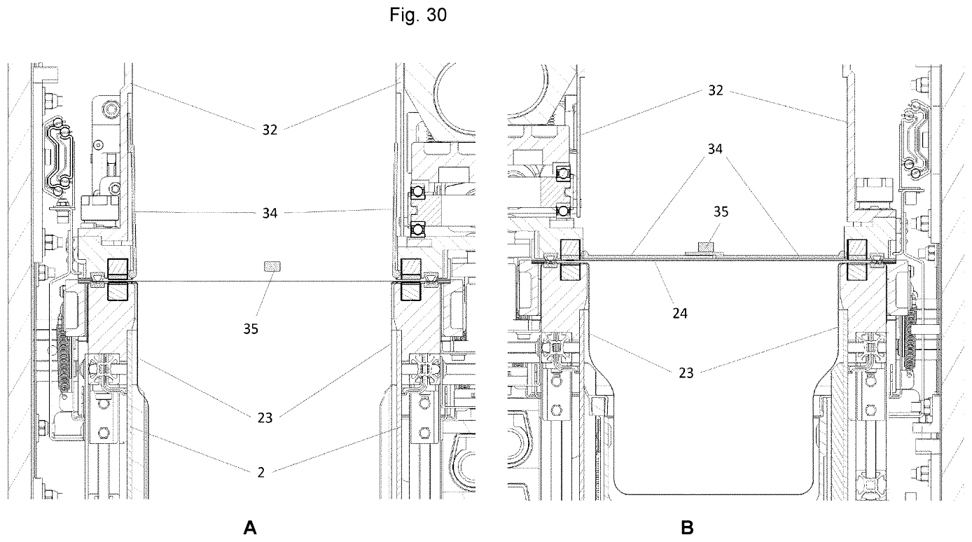

FIG. 29 shows a cross-section of a device according to the invention in the second embodiment corresponding to FIG. 17. The device comprises two containers, in the left-hand container the base is lowered and the closure device (34) is opened, in the right-hand container the base is raised and the closure device (34) is closed. The throw-in flap (33) is open in the left container and closed in the right. The detailed views A and B are shown in FIG. 30.

FIG. 30 shows the detailed views A and B of FIG. 29. In the left-hand detailed view A, the closure device (34) is shown opened with wings folded into the throw-in funnel (32), and the locking of the closure device (35) has been released. A waste bag (23) is inserted in the container (2). In the right-hand detailed view B, the closure device (34) in the throw-in funnel (32) is shown closed, the lock of the closure device (35) fixes the wings of the closure device (34). The closure device (34) prevents the waste from being pressed out of the waste bag (23) in the throw-in funnel (32).

According to the invention, this provides a waste container in which a comparatively large amount of waste can be collected and stored, compacted to a high degree, and then disposed of cleanly, while also being easy to operate.

### References

1 Device
2 Container
3 Side walls
4 Bottom plate
5 First seal at the opening of the container
6 Opening of the container
7 Lid device
8 Second seal on the lid device
9 Means for generating compressed air
10 Means for generating negative pressure
11 Means for thermal welding
11a Control for the means for thermal welding
12 Suction opening on the lid device
13 Seal on the bottom plate
14 Means for displacing the bottom plate
15 Inlet opening into the container
16 Inlet valve for compressed air
17 Means for fixing a waste bag
17a Seal on the means for fixing a waste bag
18 Container base
20 Protective device for UV lamp
21 Perforation means
22 Suction gap
23 Waste bag
24 Flap of the waste bag or separate part
25 Recess for perforation
26 UV lamp
27 Means for fixing the cover of the waste bag
27a Spikes for fixing the cover of the waste bag
28 Safety switch
29 Means for separating the separate part
30 Roller of the separate part to cover the waste bag
31 Means for displacing the device
32 Throw-in funnel
33 Throw-in flap
34 Closure device
35 Lock for closure device
36 Fourth seal throw-in flap
37 Lock throw-in flap

1. A mobile device for collecting and compacting waste, comprising
a) a container for receiving a waste bag comprising side walls in the interior a movable bottom plate and a first seal at the opening,
b) a lid device with a second seal, the lid device being configured and arranged such that it
can be brought into an open position opposite the opening of the container so that the opening of the container is accessible for introducing a waste bag, and
can be brought into a closed position with respect to the opening of the container, so that the lid device interacts positively with the opening of the container in such a way that a waste bag introduced into the container can be sealed airtight against the lid device between the first seal and the second seal,
c) means for generating compressed air,
d) means for generating negative pressure,
e) means for thermally welding a waste bag introduced into the container 2 when the lid device is in the closed position, the means being located at the opening of the container and/or at the lid device and
f) means for displacing the mobile device
characterized in that
the lid device has a suction opening which is arranged on the lid device in such a way that, in the closed position, the gaseous atmosphere can be partially extracted from the interior of a waste bag introduced into the container by means of the means for generating negative pressure, the container, when the opening is closed, is airtight,
the bottom plate of the container is displaceable with respect to the side walls and in the closed position in the direction of the lid device the device has means for displacing the bottom plate with respect to the side walls and the container has an inlet opening for compressed air, which can be supplied with compressed air, which is provided by the means for generating compressed air, in a controlled manner by means of an inlet valve

2. The mobile device according to claim 1, wherein the lid device comprises a throw-in funnel and a throw-in flap. wider

3. The mobile device according to claim 1, wherein the means for displacing the bottom plate are driven with compressed air provided by the means for generating compressed air.

4. The mobile device according to claim 1, which is configured such that the compressed air used for the means for displacing the bottom plate can also be guided to the inlet opening in a controlled manner by means of an inlet valve.

5. The mobile device according to claim 1, wherein the means for displacing the bottom plate are pneumatically operated.

6. The mobile device according to claim 1, wherein the means for generating negative pressure.

7. The mobile device according to claim 1, wherein the means for generating negative pressure comprise a filter.

8. The mobile device according to claim 1, wherein the lid device.

9. The mobile device according to claim 1, wherein the device has means for fixing a waste bag.

10. The mobile device according to claim 1, wherein the device has means for displacing the device.

11. A method for collecting and compacting waste performed by the device of claim 1, comprising the step of extracting a part of the gaseous atmosphere from a waste bag containing waste, while simultaneously mechanically compressing the waste bag and subjecting the waste bag to external air pressure.

12. The method according to claim 11, wherein prior to the step of extracting a part of the gaseous atmosphere from a waste bag containing waste, while simultaneously mechanically compressing the waste bag and subjecting the waste bag to external air pressure, a step is first performed in which only the waste bag is mechanically compressed, followed by the additional extraction of a first part of the gaseous atmosphere from a waste bag.

13. The method according to claim 11, wherein, before the step of extracting a part of the gaseous atmosphere from a waste bag containing waste, while simultaneously mechanically compressing the waste bag and subjecting the waste bag to external air pressure, the waste bag is closed by means of a part of the bag or a separate part of the waste bag by pressing on the part, this part of the bag or a separate part of the waste bag is perforated, and a part of the gaseous atmosphere is extracted from the waste bag through the perforation opening.

14. The method according to claim 11, further comprising a step of closing the waste bag by thermal welding during or after the extraction of a part of the gaseous atmosphere from a waste bag.

15. The mobile device of claim 2, wherein the throw-in funnel is configured to carry the second seal at the tapered end.

16. The mobile device of claim 2, wherein the throw-in flap is configured to close the throw-in funnel at the wider end.

17. The mobile device of claim 16, wherein the throw-in flap is configured to close the throw-in funnel in an airtight manner.

18. The mobile device of claim 2, further comprising means for perforating a waste bag.

19. The mobile device of claim 5, wherein the means for displacing the bottom plate are one or more pneumatic cylinders or one or more pneumatic bellows.

20. The mobile device of claim 6, wherein the means for generating negative pressure comprises a vacuum pump.
